(19) United States
(12) Patent Application Publication
(10) Pub. No.: US 2010/0302587 A1
(43) Pub. Date: Dec. 2, 2010

(54) IMAGE PRINTING SYSTEM, IMAGE FORMING APPARATUS, PRINTER SELECTION APPARATUS, TERMINAL APPARATUS, AND RECORDING MEDIUM HAVING RECORDED THEREIN PRINTER DRIVER

(75) Inventors: Mie KAWABATA, Toyokawa-shi (JP); Takashi Oikawa, Toyohashi-shi (JP); Shinichi Asai, Gamagoori-shi (JP); Tomokazu Kato, Toyokawa-shi (JP); Hiroshi Iwamoto, Toyohashi-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/790,225

(22) Filed: May 28, 2010

(30) Foreign Application Priority Data
Jun. 2, 2009 (JP) 2009-133091

(51) Int. Cl. G06F 3/12

(52) U.S. Cl. 358/1.15

(57) ABSTRACT

A certain PC selects an MFP expected to complete a print job the earliest based on the number of print jobs being spooled in each MFP, and outputs the print job to the selected MFP. Despite this, there occurs a problem that it takes longer time to complete the print job than a user thought due to that other PC has output a print job to the selected MFP substantially simultaneously with the certain PC. In view of this problem, according to the present invention, a terminal information management unit included in each MFP manages the default setting number that is the number of PCs that each set the MFP as its default MFP for ordinary use. A PC selects an MFP to which a print job is to be output based on the default setting number collected from each MFP, and outputs the print job to the selected MFP.

This application is based on an application No. 2009-133091 filed in Japan, the content of which is hereby incorporated by reference.

### BACKGROUND OF THE INVENTION

(1) Field of the Invention

The present invention relates to an image printing system that includes a plurality of image forming apparatuses and a plurality of terminal apparatuses, and particularly to an art of selecting one of the image forming apparatuses that is expected to complete a print job the earliest.

(2) Description of the Related Art

In the case where a terminal apparatus is connected with a plurality of image forming apparatuses, the terminal apparatus in advance sets one of the plurality of image forming apparatuses as an image forming apparatus for ordinary use. Then, the terminal apparatus outputs a print job to the set image forming apparatus.

The Patent Literature 1 discloses an art of selecting one of a plurality of image forming apparatuses that is expected to complete a print job the earliest.

Specifically, each terminal apparatus collects various types of information to select one of the image forming apparatuses that is expected to complete a print job the earliest, and then outputs the print job to the selected image forming apparatus. The various types of information includes: (a) a printing speed and a resolution of each image forming apparatus; (b) the number of jobs spooled in each image forming apparatus and an amount of the spooled jobs; and (c) the number of terminal apparatuses included in a system and the capability of the terminal apparatuses, the number of image forming apparatuses included in the system and the capability of the image forming apparatuses, and the number of servers included in the system and the capability of the servers.

However, in the case where the art disclosed in the Patent Literature 1 is employed, there might occur the following problem: despite selection of an image forming apparatus expected to complete the earliest a print job output from a certain terminal apparatus, other terminal apparatus outputs a print job to the selected image forming apparatus substantially simultaneously with the certain terminal apparatus outputs a print job, and this results in longer time to complete the print job output from the certain terminal apparatus than a user thought.
Patent Literature 1: Japanese Patent Application Publication No. H10-157253

### SUMMARY OF THE INVENTION

The present invention is made in view of the above problem, and aims to provide an image printing system, an image forming apparatus, a printer selection apparatus, a terminal apparatus, and a recording medium having recorded therein a printer driver that are capable of reducing the risk of occurrence of the above problem.

In order to achieve the above aim, the present invention provides an image printing system that includes a plurality of image forming apparatuses and a plurality of terminal apparatuses that are connected with one another via a network, wherein each image forming apparatus manages a setting number that is a number of terminal apparatuses that each set the image forming apparatus as a default image forming apparatus for ordinary use, and each terminal apparatus selects, as a destination image forming apparatus to which a print job is to be output, one of the image forming apparatuses based on the setting number managed by each image forming apparatus, and outputs the print job to the selected destination image forming apparatus.

### BRIEF DESCRIPTION OF THE DRAWINGS

These and the other objects, advantages and features of the invention will become apparent from the following description thereof taken in conjunction with the accompanying drawings which illustrate a specific embodiment of the invention. In the drawings:

FIG. 1 shows the system structure of an image printing system 1;

FIG. 2 is a block diagram showing the functional structure of an MFP 1(10);

FIG. 3 is a block diagram showing the functional structure of a printer selection support unit 110;

FIG. 4 is a block diagram showing the hardware structure of a PC 1(40);

FIG. 5 is a block diagram showing the functional structure of a printer selection unit 410;

FIG. 6(a) shows information managed by a terminal information management unit 213 and a job management unit 216 included in an MFP 2(20), and FIG. 6(b) shows information managed by a terminal information management unit 313 and a job management unit 316 included in an MFP 3(30);

FIG. 7 shows a printer selection screen 420 generated by a selection unit 416 relating to a first embodiment;

FIG. 8 is a flow chart showing the whole operations performed in the image printing system 1;

FIG. 9 is a flow chart showing operations of default setting processing;

FIG. 10 is a flowchart showing operations of printer selection processing;

FIG. 11 shows a printer selection screen 430 generated by a selection unit 416 relating to a first modification;

FIG. 12 is a flow chart showing part of operations of printer selection processing relating to the first modification;

FIG. 13 is a flow chart showing part of operations of printer selection processing relating to a second modification;

FIG. 14 is a flow chart showing part of operations of printer selection processing relating to a third modification;

FIG. 15 shows information managed by a job management unit 116 relating to a second embodiment;

FIG. 16 shows a printer selection screen 440 generated by a selection unit 416 relating to the second embodiment;

FIG. 17 is a flow chart showing the whole operations of an image printing system relating to the second embodiment;

FIG. 18 is a flow chart showing operations of printer selection processing relating to the second embodiment;

FIG. 19 is a flow chart showing operations of the printer selection processing relating to the second embodiment;

FIG. 20 is a flow chart showing operations of the printer selection processing relating to the second embodiment;

FIG. 21 is a flowchart showing operations of history information update processing relating to the second embodiment;

FIG. 22 is a flow chart showing a modification of default setting notification processing; and

FIG. 23 is a flow chart showing a modification of the default setting notification processing.

### DESCRIPTION OF THE PREFERRED EMBODIMENTS

### First Embodiment

The following describes an image printing system 1 that is a first embodiment relating to the present invention, with reference to the drawings.

<Structure>

1. System Structure

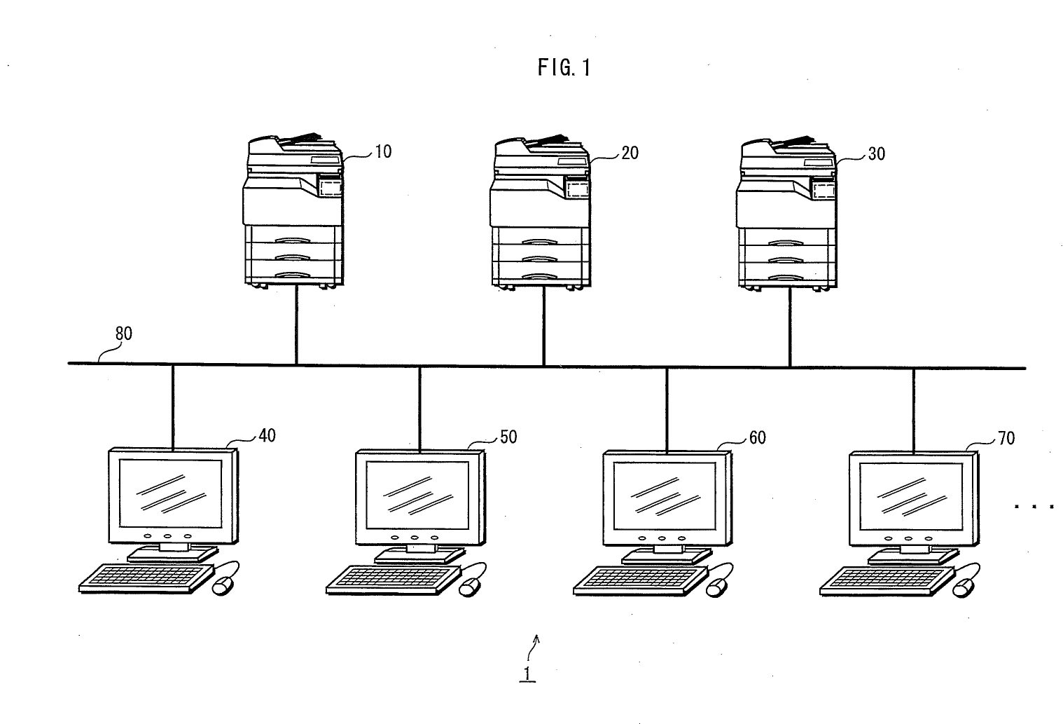

FIG. 1 shows the whole system structure of the image printing system 1.

As shown in FIG. 1, the image printing system 1 includes a plurality of MFPs (Multi Function Peripherals) and a plurality of PCs (Personal Computers) that are connected with one another via a LAN (Local Area Network) 80.

Specifically, the image printing system 1 includes three image forming apparatuses of an MFP 1(10), an MFP 2(20), and an MFP 3(30) and a plurality of PCs including a PC 1(40), a PC 2(50), a PC 3(60), and a PC 4(70). Although FIG. 1 shows only four PCs of the PC 1(40) to the PC 4(70), the image printing system 1 includes a PC 5 to a PC 10 in addition to the PC 1 to the PC 4.

In the image printing system 1, each PC sets one of the MFPs as a “default printer” that is a printer for ordinary use. Hereinafter, processing performed by a PC for setting one MFP, namely, a certain one image forming apparatus, to a “default printer” is referred to as “default setting”. When necessary to output a print job, each PC ordinarily outputs a print job to an MFP set as its default printer.

Also, each MFP manages the default setting number that indicates the number of PCs that each set the MFP as a default printer. When necessary to output an urgent print job, each PC does not output the urgent print job to its default printer, but collects the default setting number managed by each MFP. The PC selects one of the MFPs that is expected to complete the urgent print job the earliest based on the default setting numbers collected from the MFPs. Then, the PC outputs the urgent job to the selected MFP.

2. Structure of MFP 1(10)

The structure of the MFP 1(10) is described here.

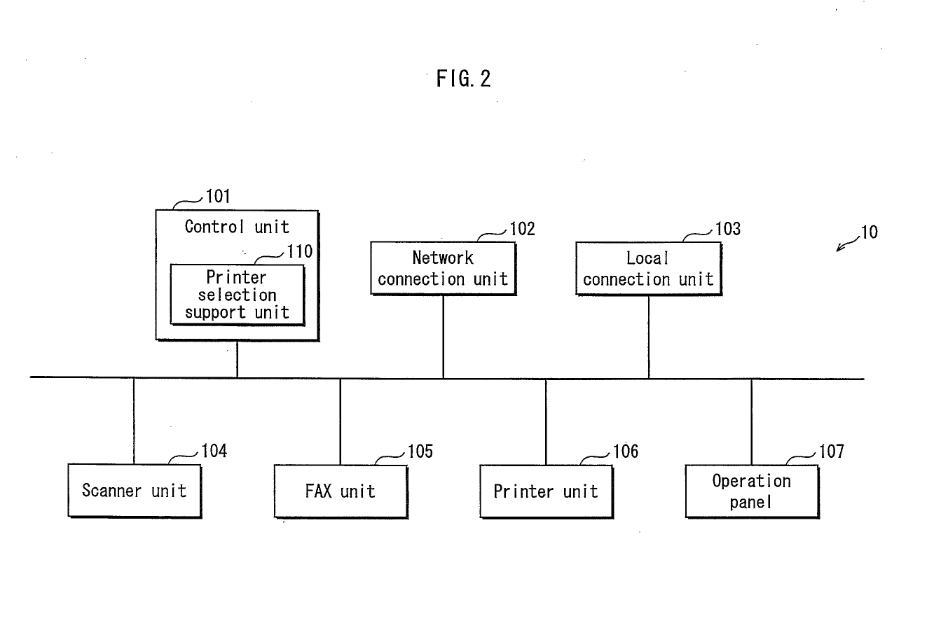

FIG. 2 is a functional block showing the structure of the MFP 1(10). As shown in FIG. 2, the MFP 1(10) includes a control unit 101, a network connection unit 102, a local connection unit 103, a scanner unit 104, a FAX unit 105, a printer unit 106, and an operation panel 107.

The control unit 101 includes a CPU, a ROM, a RAM, an HDD, and so on. The HDD or the ROM stores therein various computer programs for causing the MFP 1(10) to function, such as a whole control program, an image processing program, and a network control program.

The control unit 101 controls other units thereby to control the functions and operations of the whole MFP 1(10) by the CPU executing the various computer programs with use of a working RAM.

The control unit 101 includes, as shown in FIG. 1, a printer selection support unit 110 that is a characteristic compositional element of the present invention. The details of the printer selection support unit 110 are described later.

The network connection unit 102 includes an Ethernet™ port (not shown). The Ethernet™ port is a port for connecting the MFP 1 to the LAN 80. The MFP 1(10) transmits and receives information to and from each PC via the LAN 80.

The local connection unit 103 is an interface for connecting the PCs to the network via a parallel port.

When the control unit 101 receives scanning processing, the scanner unit 104 scans an image such as a character, a graphic, and a photograph from a paper document to generate image data composed of electronic data. Note that the scanner unit 104 may include an ADF for automatically scanning a plurality of paper documents and an apparatus having a Duplex function for performing both side scanning.

The FAX unit 105 functions as a modem for transmitting and receiving FAX data via a public line.

Upon receiving a print job from the control unit 101, the printer unit 106 prints data that has been converted for printing on a paper, and outputs the data as a paper document. Note that the printer unit 106 may include a finisher having a finishing function such as a sort, a punch, and a stable.

The operation panel 107 includes a touch panel liquid crystal display or an organic EL display, and various keys such as a ten-key, a start key, a stop key, and a screen switching key. The operation panel 107 functions as a dedicated control device for the user to operate the MFP 1(10). On the touch panel liquid crystal display or the organic EL display, various screens output by the control unit 101 are displayed.

Also, the user operates the operation panel 107 to input an instruction such as a print job and a FAX job to the MFP 1(10).

(Structure of Printer Selection Support Unit 110)

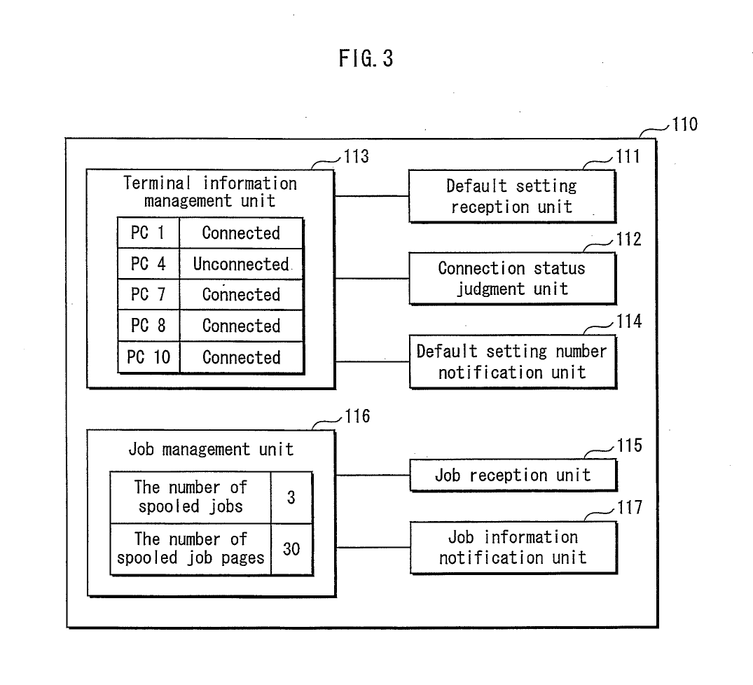

FIG. 3 is a functional block diagram showing the internal structure of the printer selection support unit 110.

As shown in FIG. 3, the printer selection support unit 110 includes a default setting reception unit 111, a connection status judgment unit 112, a terminal information management unit 113, a default setting number notification unit 114, a job reception unit 115, a job management unit 116, and a job information notification unit 117.

The default setting reception unit 111 receives a notification of default setting from each PC. The notification of default setting includes an identification information piece of each PC and an identification information piece of a default printer set by the PC. The identification information piece of each PC may be any information by which the PC is uniquely identifiable. Specifically, the identification information piece of each PC may be an IP address or a MAC address of the PC, an ID of a printer driver, or the like. Also, the identification information piece of each MFP may be any information by which the MFP is uniquely identifiable.

The default setting reception unit 111 outputs the received identification information pieces of the PCs and the identification information pieces of the MFPs to the terminal information management unit 113.

Note that the default setting reception unit 111 receives a notification of default setting from each PC when the system is started up and when the PC changes its default printer.

When the system is started up, the default setting reception unit 111 receives a notification of default setting from each PC. Then, each time any of the PCs changes its default printer, the default setting reception unit 111 receives a notification of default setting from the PC that has changed its default printer.

Note that when the system is started up, no information is recorded in the terminal information management unit 113. Accordingly, at this time, the default setting reception unit 111 does not necessarily need to receive a notification of default setting from each PC. The default setting reception unit 111 only needs to receive a notification of default setting from at least a PC that sets the MFP 1(10) as its default printer.

The connection status judgment unit 112 periodically makes connection status judgment for judging whether a PC that sets the MFP 1 as its default printer is connected to the LAN 80. The connection status judgment unit 112 beforehand stores therein time information for determining a time at which the connection status judgment needs to be performed. The connection status judgment unit 112 counts a time, and makes connection status judgment on the PC at a fixed time with reference to the time information. Then, the connection status judgment unit 112 outputs a result of the connection status judgment to the terminal information management unit 113.

The terminal information management unit 113 manages, as shown in FIG. 3, an identification information piece of a PC that sets the MFP 1 as its default printer and a connection status of the PC in correspondence with each other. In the example shown in FIG. 3, a PC name such as a “PC 1” and a “PC 4” is used as an identification information piece of each PC.

According to the example shown in FIG. 3, five PCs of the PC 1, the PC 4, the PC 7, the PC 8, and the PC 10 each set the MFP 1 as its “default printer”. Also, the PC 1, the PC 7, the PC 8, and the PC 10 are currently connected to the LAN 80, and the PC 4 is currently not connected to the LAN 80.

Each time there occurs a change in default setting or connection status of each PC, the terminal information management unit 113 updates information managed therein. For example, when a PC newly sets the MFP 1 as its default printer, the terminal information management unit 113 records therein a PC name of the PC that has newly set the MFP 1. When a PC changes its default printer from the MFP 1 to another one of the MFPs, the terminal information management unit 113 deletes a PC name of the PC that has changed its default printer.

The default setting number notification unit 114 notifies a particular PC of the default setting number.

Specifically, upon receiving a transmission request for the default setting number from a PC, the default setting number notification unit 114 calculates the default setting number based on the information recorded in the terminal information management unit 113. The default setting number specifically indicates the number of PCs that each set the MFP 1 as its default printer and are currently connected to the LAN 80.

For example, in the case where the terminal information management unit 113 records therein the PC names and the connection statuses shown in FIG. 3, the MFP 1 is set as a default printer by five PCs of the PC 1, the PC 4, the PC 7, the PC 8, and the PC 10. Since only the PC 4 among these five PCs is in a connection status “unconnected”, the number of PCs in a connection status “connected” is four. Accordingly, the default setting number is four.

The default setting number notification unit 114 notifies the PC that has transmitted the transmission request of the calculated default setting number via the network connection unit 102.

Upon receiving a print job from the PC via the network connection unit 102, the job reception unit 115 outputs a reception notification of the print job and the number of pages of the received print job to the job management unit 116. Also, the job reception unit 115 outputs the received print job to the printer unit 106.

The job management unit 116 manages the number of print jobs currently being spooled in the MFP 1 and the total number of pages of the spooled print jobs (hereinafter, “the number of spooled pages”). For example, in the case shown in FIG. 3, the number of print jobs spooled in the MFP 1 is three, and the number of spooled pages is 30.

Upon receiving the reception notification of the print job and the number of pages of the received print job from the job reception unit 115, the job management unit 116 increments the number of spooled jobs and the number of spooled pages recorded therein. Furthermore, upon receiving a completion notification of a print job from the printer unit 106, the job management unit 116 also decrements the number of spooled jobs and the number of spooled pages recorded therein.

Upon receiving a transmission request for job information from a PC, the job information notification unit 117 reads the number of spooled jobs and the number of spooled pages recorded in the job management unit 116. Then, the job information notification unit 117 transmits, via the network connection unit 102, the read number of spooled jobs and the read number of spooled pages to the PC that has transmitted the transmission request for the job information.

This completes the description of the structure of the MFP 1(10). Note that the MFP 2(20) and the MFP 3(30) have the same structure as the MFP 1(10), and accordingly description thereof is omitted.

3. Structure of PC 1(40)

The structure of the PC 1(40) is described here.

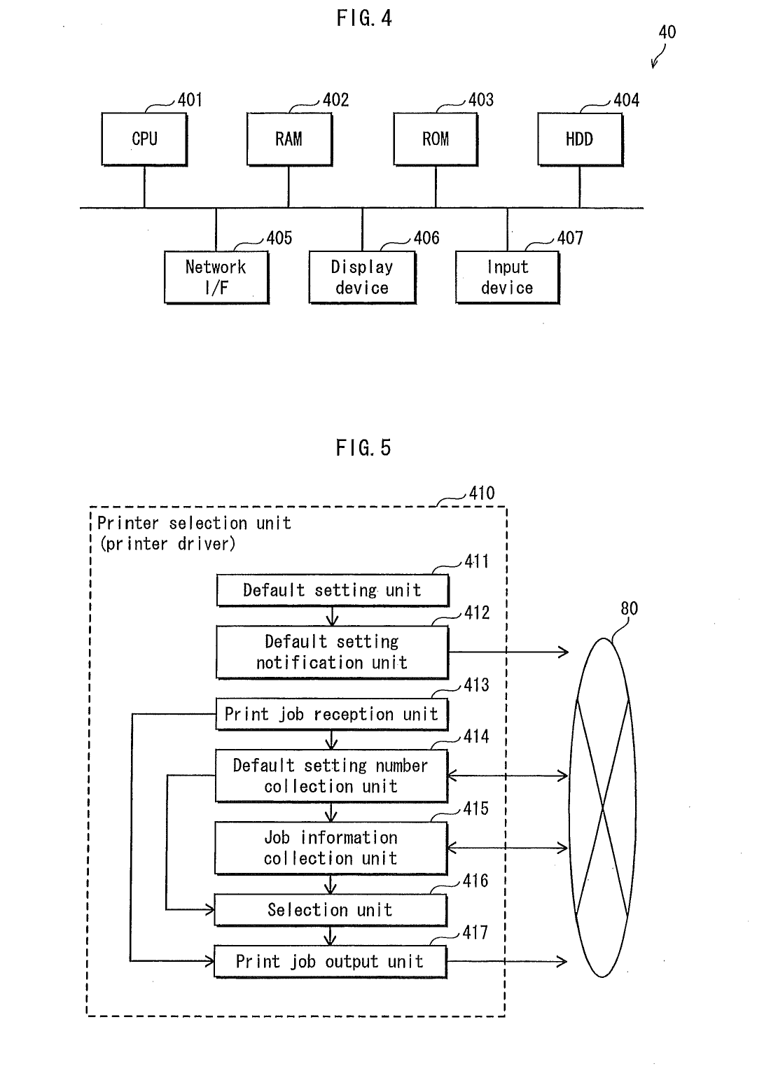

FIG. 4 is a block diagram showing the hardware structure of the PC 1(40). As shown in FIG. 4, the PC 1(40) is a computer system that includes a CPU 401, a RAM 402, a ROM 403, an HDD 404, a network I/F 405, a display device 406, and an input device 407.

The ROM 403 or the HDD 404 stores therein various computer programs for causing the PC 1(40) to function. One example of the computer programs is a printer driver for the PC 1(40) to output a print job to each MFP.

The CPU 401 controls the functions of the PC 1(40) by executing the various computer programs with use of a working RAM 402.

The network I/F 405 is a connection unit for connecting the PC 1(40) to the LAN 80, and includes an Ethernet™ port.

The display device 406 is for example a liquid crystal display, and outputs various screens.

The input device 407 is for example a keyboard and a mouse. The input device 407 receives an input from a user, and notifies the CPU 401 and the various computer programs of a signal corresponding to the received input.

The following describes a printer selection function that is a characteristic of the present invention included in the various functions realized in the PC 1(40).

(Structure of Printer Selection Unit 410)

FIG. 5 is a functional block diagram showing the structure of the printer selection unit 410.

As shown in FIG. 5, the printer selection unit 410 includes a default setting unit 411, a default setting notification unit 412, a print job reception unit 413, a default setting number collection unit 414, a job information collection unit 415, a selection unit 416, and a print job output unit 417.

The printer selection unit 410 is specifically realized by the above hardware structure and part of the printer driver.

The default setting unit 411 receives a default setting of printer via a user's input. Also, when the user changes the default setting of printer, the default setting unit 411 receives the change in the same way.

The default setting indicates that each PC sets one MFP as its “default printer” for ordinary use, as described above. For example, in the case where the PC 1 is Windows™-based, the user refers to a property of each MFP via the Windows™ Control Panel thereby to perform default setting and cancel default setting. The default setting unit 411 stores therein the received default setting.

The default setting notification unit 412 notifies the MFP 1(10), the MFP 2(20), and the MFP 3(30) of the default setting received by the default setting unit 411.

For example, in the case where the default setting unit 411 sets the MFP 1(10) as its default printer, the default setting notification unit 412 transmits identification information of the MFP 1(10) and identification information of the PC 1(40) to an IP address of a port of each MFP. Here, the default setting notification unit 412 beforehand stores therein the identification information of the PC 1(40).

The default setting notification unit 412 notifies all of the MFPs of the identification information of the MFP 1(10) and the identification information of the PC 1(40). This enables the MFP 1(10), which has been newly set as the default printer by the PC 1(40), to update information managed therein. Furthermore, the MFP 2(20) or the MFP 3(30) can update information managed therein as necessary.

More specifically, in the case where the PC 1(40) sets the MFP 2(20) as its default printer, a terminal information management unit of the MFP 2(20) records therein a PC name “PC 1” as identification information of the PC 1(40). Here, in the case where the PC 1(40) changes its default printer from the MFP 2(20) to the MFP 1(10), the terminal information management unit of the MFP 2(20) needs to delete the PC name “PC 1”.

Accordingly, the default setting notification unit 412 notifies all of the MFPs (the MFP 1(10), the MFP 2(20), and the MFP 3(30)) of the default setting received by the default setting unit 411.

The print job reception unit 413 receives a printing instruction of a document from the user. Upon receiving the printing instruction, the print job reception unit 413 instructs the default setting number collection unit 414 to collect the default setting numbers.

Upon being instructed by the print job reception unit 413, the default setting number collection unit 414 collects the default setting number from each of the MFP 1, the MFP 2, and the MFP 3. Then, the default setting number collection unit 414 outputs the default setting numbers collected from the MFPs to the selection unit 416.

Also, after collecting the default setting numbers from the MFPs, the default setting number collection unit 414 instructs the job information collection unit 415 to collect job information pieces.

Upon being instructed by the default setting number collection unit 414, the job information collection unit 415 collects a job information piece from each of the MFP 1, the MFP 2, and the MFP 3. Here, the job information piece indicates the number of print jobs currently being spooled in the MFP and the total number of pages of the spooled jobs (the number of spooled pages). Then, the job information collection unit 415 outputs the number of spooled jobs and the number of spooled pages acquired from each MFP to the selection unit 416.

The selection unit 416 receives the default setting number with respect to each MFP from the default setting number collection unit 414, and receives the number of spooled jobs and the number of spooled pages from the job information collection unit 415.

The selection unit 416 generates a printer selection screen based on the default setting numbers, the numbers of spooled jobs, and the number of spooled pages. Then, the selection unit 416 displays the generated printer selection screen on the display device 406, and receives, via the input device 407, selection of a destination MFP of the print job, that is, an MFP to which the print job is to be output.

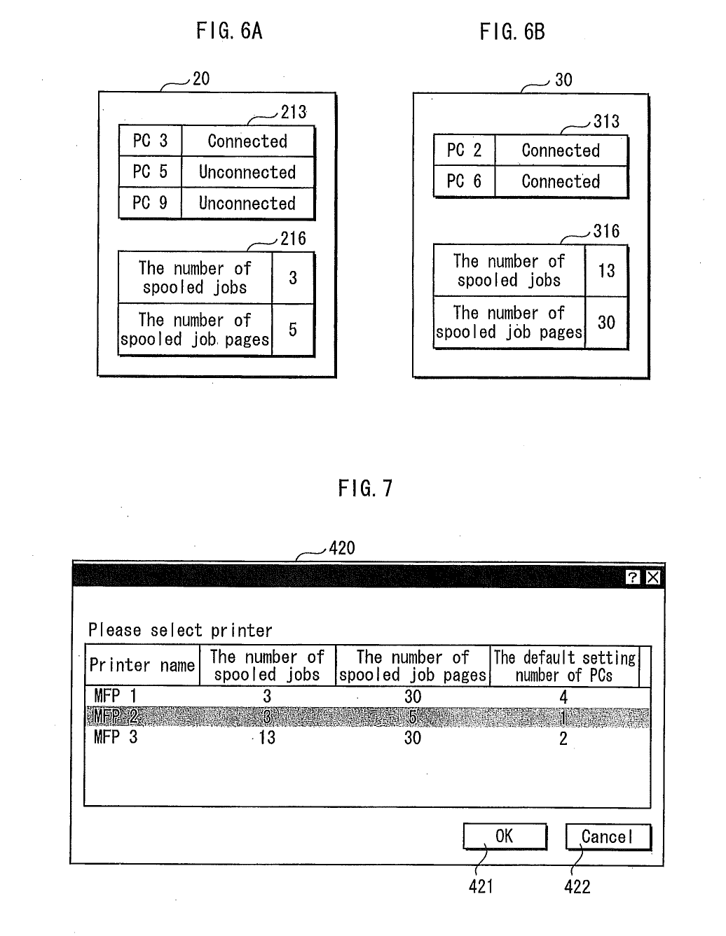

The selection unit 416 generates a printer selection screen 420 shown in FIG. 7 in the case where for example: the terminal information management unit 113 and the job management unit 116 of the MFP 1(10) manage the information shown in FIG. 3; a terminal information management unit 213 and a job management unit 216 of the MFP 2(20) manage information shown in FIG. 6(a); and a terminal information management unit 313 and a job management unit 316 of the MFP 3(30) manage information shown in FIG. 6(b).

The printer selection screen 420 includes, with respect to each of the MFP 1(10), the MFP 2(20), and the MFP 3(30), a table, an OK key 421, and a Cancel key 422. In the table, a printer name, the number of spooled jobs, the number of spooled pages, and the default setting number are stored in correspondence with one another.

As shown in FIG. 7, the number of jobs spooled in the MFP 1(10) is three, and the number of spooled pages is 30. These numerical values are the same as those managed by the job management unit 116 shown in FIG. 3. Also, the default setting number with respect to the MFP 1(10) is four. This is because, among five PCs managed by terminal information management unit 113 as shown in FIG. 3, the number of PCs currently connected to the LAN 80 is four.

Similarly, as shown in FIG. 7, the number of jobs spooled in the MFP 2(20) is three, and the number of spooled pages is five. These numerical values are the same as those managed by the job management unit 216 shown in FIG. 6(a). Also, the default setting number with respect to the MFP 2(20) is one. This is because, among three PCs managed by the terminal information management unit 213 shown in FIG. 6(a), the number of PCs currently connected to the LAN 80 is one.

Similarly, as shown in FIG. 7, the number of jobs spooled in the MFP 3(30) is 13, and the number of spooled pages is 30. These numerical values are the same as those managed by the job management unit 316 shown in FIG. 6(b). Also, the default setting number with respect to the MFP 3(30) is two. This is because two PCs managed by the terminal information management unit 313 shown in FIG. 6(b) are both currently connected to the LAN 80.

The user selects an MFP that is expected to complete the print job the earliest, with reference to the printer selection screen 420 displayed on the display device 406.

According to the printer selection screen 420, the numbers of print jobs currently being spooled in the MFP 1(10) and the MFP 2(20) are three, respectively. In this case, if the MFP 2(20) having the less default setting number is selected, the user of the PC 1(40) and other user are unlikely to simultaneously output print jobs to the PC 1(40), and the print job output from the PC 1(40) is likely to be completed earlier compared with the case where the MFP 1(10) is selected.

Also, according to the printer selection screen 420, the numbers of pages of print jobs currently being spooled in the MFP 1(10) and the MFP 3(30) are 30, respectively. In this case, if the MFP 3(30) having the less default setting number is selected, the user of the PC 1(40) and other user are unlikely to simultaneously output print jobs to the MFP 3(30), and the print job output from the PC 1(40) is likely to be completed earlier compared with the case where the MFP 1(10) is selected.

If the user selects the MFP 2(20) using the input device 407, shading is applied to a row for the MFP 2(20) on the printer selection screen 420 (the row may be highlighted). Then, if the user clicks the OK key 421, the selection unit 416 selects the MFP 2(20) and notifies the print job output unit 417 of a result of the selection.

Also, if the user clicks the Cancel key 422, the selection unit 416 selects a default printer (MFP 1(10) here, because the PC 1 currently sets the MFP 1 as its default printer), and notifies the print job output unit 417 of a result of the selection.

The print job output unit 417 outputs the print job received by the print job reception unit 413 to the MFP selected by the selection unit 416.

This completes the description of the structure of the PC 1(40). Note that other PCs such as the PC 2(50) and the PC 3(60) have the same structure as the PC 1(40), and accordingly description thereof is omitted.

<Operations>

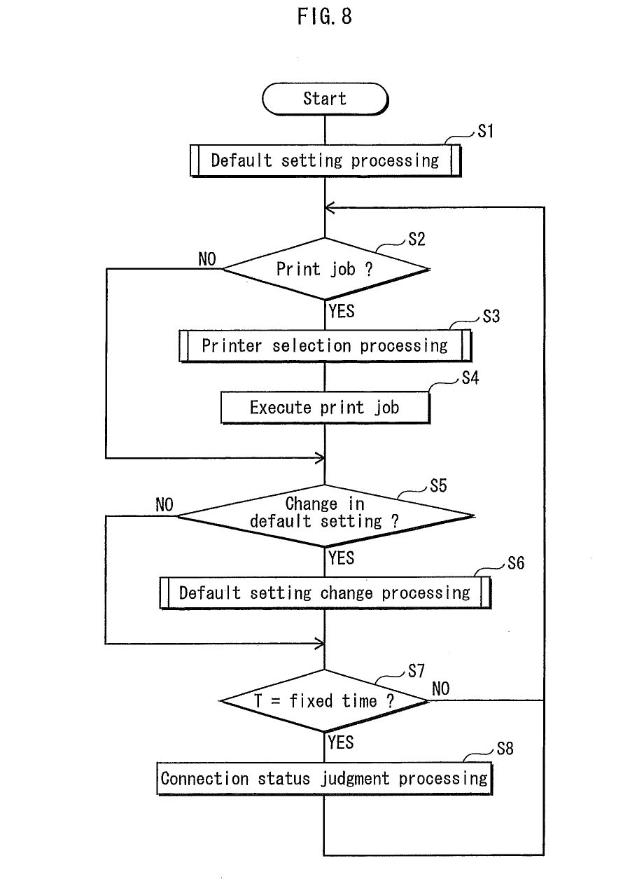

The operations of the image printing system 1 are described here with reference to flow charts shown in FIG. 8 to FIG. 10.

1. Operations of Whole System

Firstly, the whole operations of the image printing system 1 are described with reference to the flow chart shown in FIG. 8.

Each of the MFPs and the PCs included in the image printing system 1 performs default setting processing (Step S1). The details of Step S1 are described later.

Then, if no print job arises in all of the PCs (Step S2: NO), the flow proceeds to Step S5. If a print job arises in any of the PCs (Step S2: YES), the PC in which the print job has arisen and each MFP performs printer selection processing (Step S3). The details of Step S3 are described later.

Then, one MFP selected in Step S3 executes the print job. After executing the print job, the MFP updates its job information (Step S4).

Next, if no change arises in default setting of all of the PCs (Step S5: NO), the flow proceeds to Step S7. If a change arises in default setting of any of the PCs (Step S5: YES), the PC that has changed its default setting and each MFP perform default setting change processing (Step S6). The details of Step S6 are described later.

Then, the connection status judgment unit of each MFP judges whether the current time is a time for making judgment on the connection status, with reference to a current time T and time information. If the current time is not a time for making judgment on the connection status (Step S7: NO), the flow returns to Step S2 and each MFP and each PC continue processing.

If the current time is a time for making judgment on the connection status (Step S7: YES), the connection status judgment unit of each MFP judges whether a PC that sets the MFP as its default printer is connected to the LAN 80 (Step S8). Then, as necessary, the terminal information management unit updates information recorded therein. Then, the flow returns to Step S2 and each MFP and each PC continue processing.

2. Operations of Default Setting Processing

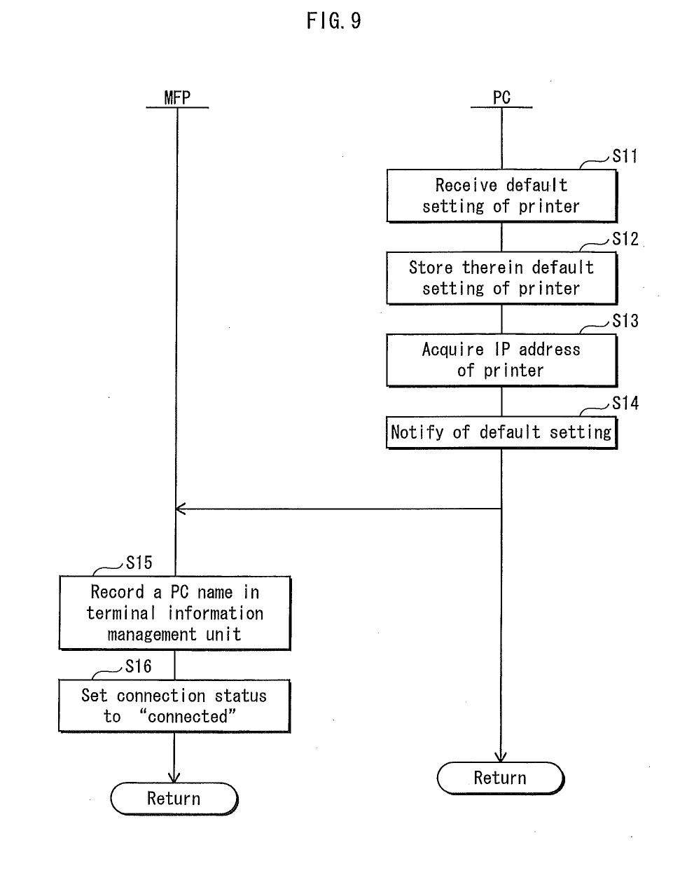

The operations of the default setting processing are described here with reference to the flow chart shown in FIG. 9. The operations described here are the details of Step S1 shown in FIG. 8.

Firstly, the default setting unit of each PC receives a default setting of printer via the user's input (Step S11). The default setting unit stores therein a printer name of the MFP set as the default printer (Step S12), and outputs the printer name of the MFP to the default setting notification unit.

Then, the default setting notification unit of each PC acquires an IP address of each of the MFP 1(10), the MFP 2(20), and the MFP 3(30) (Step S13), and transmits the printer name of the default printer and a PC name of the PC to the acquired IP addresses of (Step S14).

The default setting reception unit of each MFP receives the notification of default setting from each PC.

When an MFP is set as a default printer by a PC, the MFP records a PC name of the PC in the terminal information management unit. Also, when an MFP is not set as a default printer by any PC, the MFP discards information of the received notification of the default setting (Step S15).

Then, the terminal information management unit of each MFP records a connection status of the PC that has set the MFP as its default printer, as “connected” (Step S16).

3. Operations of Printer Selection Processing

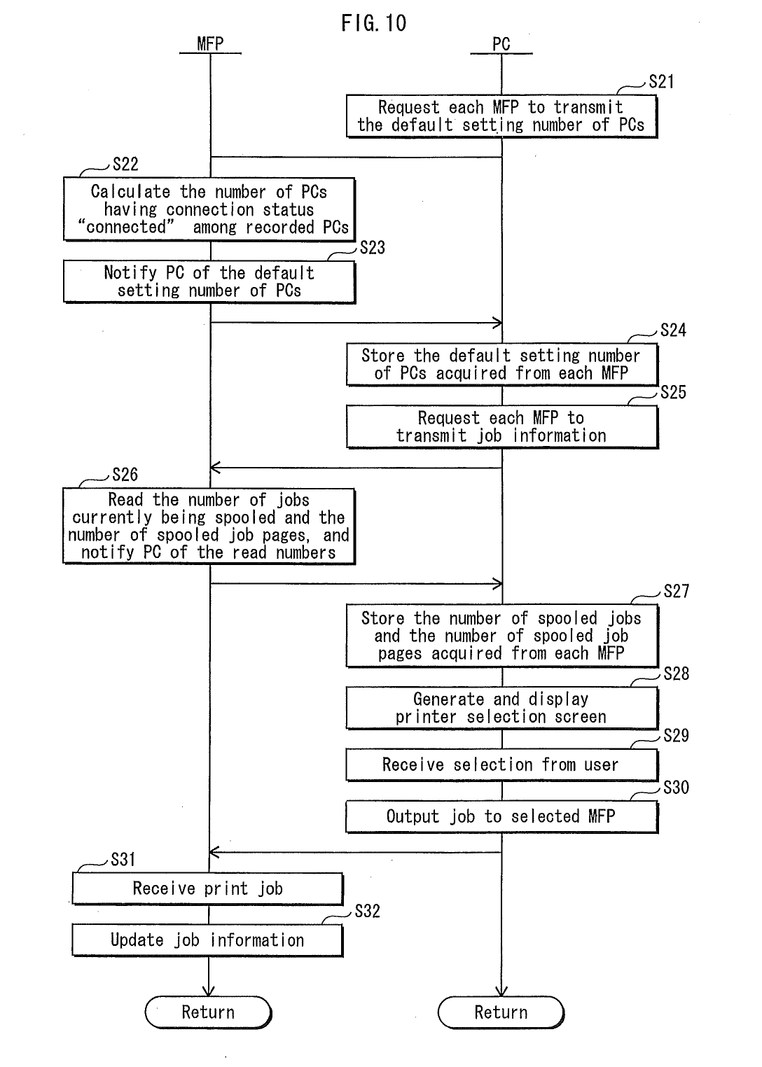

The operations of the printer selection processing are described here with reference to the flow chart shown in FIG. 10. The operations described here are the details of Step S3 shown in FIG. 8.

Upon receiving a print job, the default setting number collection unit of a PC transmits a transmission request for the default setting number to each of the MFP 1(10), the MFP 2(20), and the MFP 3(30) (Step S21).

Upon receiving the transmission request for the default setting number from the PC, the default setting number notification unit of each MFP calculates the number of PCs whose connection status is “connected” among PCs registered in the terminal information management unit (Step S22). Then, each MFP notifies the PC of the number of PCs calculated in Step S22 as the default setting number (Step S23).

The default setting number collection unit of the PC acquires the default setting number from each MFP, and the selection unit stores therein the acquired default setting numbers (Step S24).

Next, the job information collection unit of the PC transmits a transmission request for job information to each of the MFP 1(10), the MFP 2(20), and the MFP 3(30) (Step S25).

Upon receiving the transmission request for job information from the PC, the job information notification unit of each MFP reads the number of print jobs currently being spooled therein and the total number of pages of the spooled print jobs from the job management unit. Then, the job information notification unit notifies the PC of the read number of spooled jobs and the read number of pages (Step S26).

The information collection unit of the PC acquires the number of spooled jobs and the number of spooled pages from each MFP, and the selection unit stores therein the acquired number of spooled jobs and the acquired number of pages (Step S27).

Next, the selection unit generates a printer selection screen based on the default setting number, the number of spooled jobs, and the number of spooled pages that are stored therein, and displays the generated printer selection screen (Step S28).

Then, the user selects a destination MFP to which the print job is to be output with reference to the printer selection screen. The selection unit receives the user's selection (Step S29).

The print job output unit outputs the print job to the MFP selected in Step S29 (Step S30).

Upon receiving the print job from the PC (Step S31), the job reception unit of the selected MFP increments the number of spooled jobs and the number of spooled pages that are recorded in the job management unit (Step S32).

4. Operations of Default Setting Change Processing

Although the operations of the default setting change processing are substantially the same as those of the default setting processing shown in FIG. 9, only processing of Step S15 differs from that shown in FIG. 9. Only the different processing is described here.

In Step S15, when a PC newly sets an MFP as its default printer, the MFP records a PC name of the PC in the terminal information management unit. Also, when a PC changes its default printer from an MFP to another MFP, the MFP deletes a PC name of the PC from the terminal information management unit.

<First Modification>

In the first embodiment, the user selects a destination MFP of a print job with reference to the printer selection screen. The following describes, as a first modification of the first embodiment, an embodiment in which the printer selection unit of a PC can automatically select a destination MFP.

The following mainly describes the difference from the first embodiment.

Firstly, the first modification differs from the first embodiment in a printer selection screen generated by the printer selection unit of each PC.

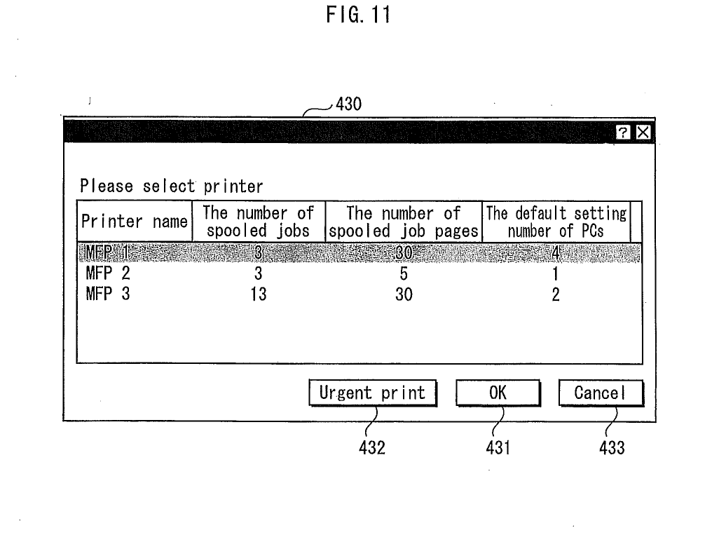

A printer selection screen 430 shown in FIG. 11 is a specific example of a printer selection screen generated by a printer selection unit relating to the first modification. As shown in FIG. 11, the printer selection screen 430 includes an urgent print key 432, which is not included in the printer selection screen 420 of the first embodiment.

Next, operations of printer selection processing relating to the first modification are described.

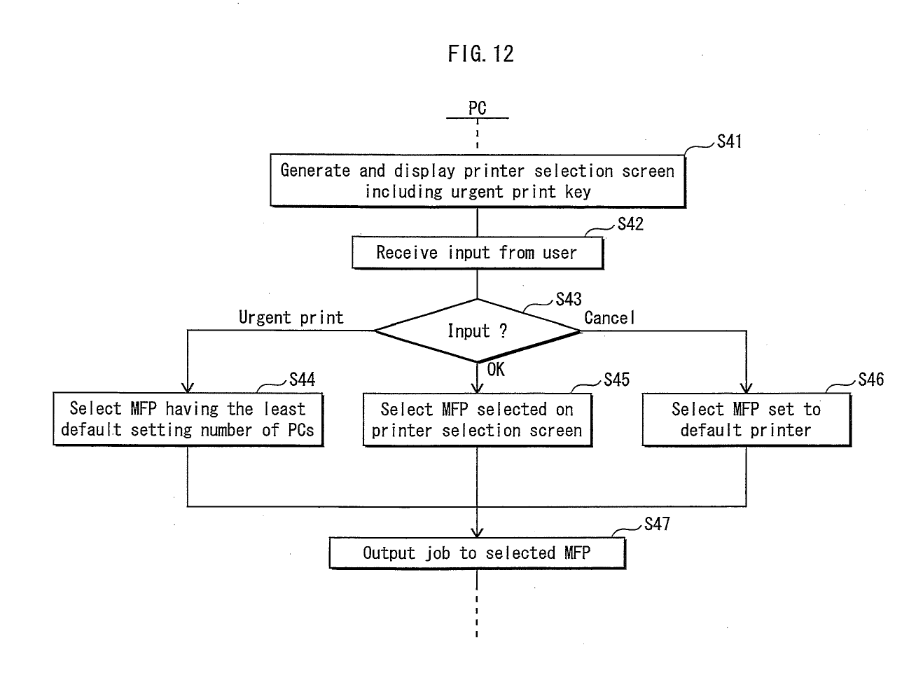

FIG. 12 is a flow chart showing the operations of the printer selection processing with use of the printer selection screen 430.

Here, Steps S28 to S30 shown in FIG. 10 are replaced with the flow chart (Steps S41 to S47) shown in FIG. 12, and only operations different from those in the first embodiment are described. Other operations are the same as those in the first embodiment.

The printer selection unit generates a printer selection screen including an “urgent print key” based on the default setting number, the number of spooled jobs, and the number of spooled pages that are stored therein, and displays the generated printer selection screen (Step S41).

Then, the selection unit receives an input from the user (Step S42).

If the user clicks the urgent print key (Step S43: “urgent printing”), the selection unit retrieves an MFP having the least default setting number. Then, the selection unit selects the retrieved MFP as a destination MFP of a print job (Step S44). In an example of the printer selection screen 430 shown in FIG. 11, the MFP 2 is selected.

In Step S44, if a plurality of MFPs having the least default setting number are retrieved, the printer selection unit selects one of the plurality of MFPs that has been retrieved first.

If the user clicks the OK key (Step S43: “OK”), the selection unit selects an MFP selected on the printer selection screen as the destination MFP of the print job (Step S45). In an example of the printer selection screen 430 shown in FIG. 11, the MFP 1 is selected.

If the user clicks the Cancel key (Step S43: “Cancel”), the selection unit selects, as the destination MFP of the print job, an MFP set as its default printer (Step S46).

Then, the print job output unit outputs the print job to the MFP selected in any of Steps S44, S45, and S46 (Step S47).

In other words, the operations in the case where the user clicks the OK key 431 and the operations in the case where the user clicks the Cancel key are the same as those in the first embodiment, respectively.

In the first modification, in the case where the user hopes to output an urgent print job, the user can select an MFP that is expected to complete the urgent print job the earliest, by simply clicking the urgent print key 432 without considering in detail the status of each MFP with reference to the printer selection screen 430.

<Second Modification>

The following describes, as a second modification of the first embodiment, an example in the case where a printer selection unit of a PC automatically selects a destination MFP based on the number of print jobs being spooled in each MFP in addition to the default setting with respect to each MFP.

In the second modification, like the first modification, the printer selection unit of each PC generates a printer selection screen including an urgent print key (see FIG. 11). However, the second modification differs from the first modification in operations in the case where the user clicks the urgent print key.

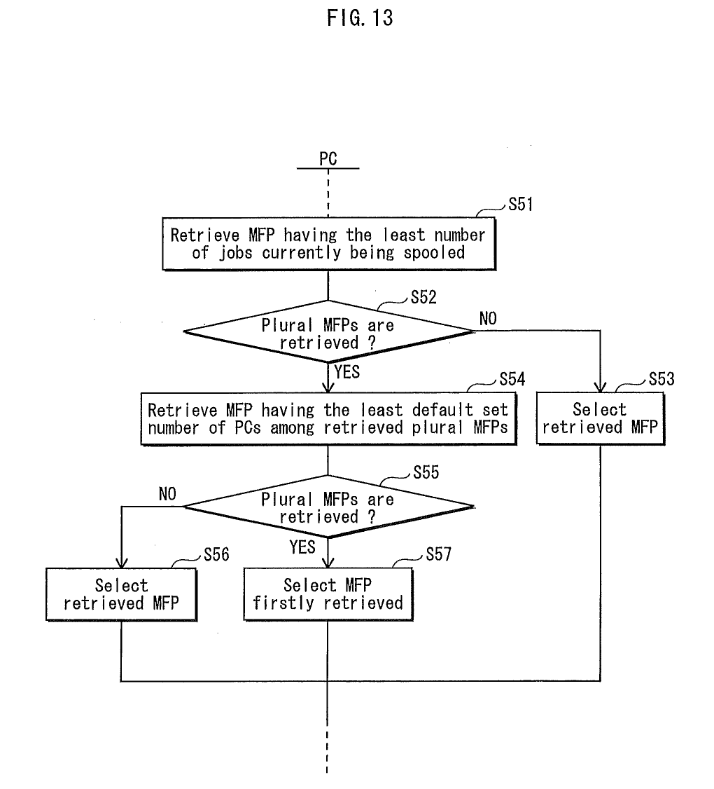

FIG. 13 is a flow chart showing the operations of printer selection processing relating to the second modification. Here, the operations of Step S44 shown in FIG. 12 are replaced with the flow (Steps S51 to S57) shown in FIG. 13, and only the operations different from those in the first embodiment and the first modification are described.

If the user clicks the urgent print key, the selection unit retrieves one of the MFPs that has the least number of spooled jobs (Step S51).

If only one MFP is retrieved in Step 51 (Step S52: NO), the selection unit selects the MFP retrieved in Step S51 as a destination MFP of a print job (Step S53).

If a plurality of MFPs are retrieved in Step S51 (Step S52: YES), the selection unit retrieves one of the retrieved plurality of MFPs that has the least default setting number (Step S54).

If only one MFP is retrieved in Step S54 (Step S55: NO), the selection unit selects the MFP retrieved in Step S54 as the destination MFP (Step S56).

If a plurality of MFPs are retrieved in Step S54 (Step S55: YES), the selection unit selects one of the MFPs that has been retrieved first in Step S54 as a destination MFP of the print job (Step S57).

In other words, in the second modification, as the first condition, an MFP having the least number of print jobs currently being spooled therein is selected.

Then, if a plurality of MFPs have the least number of spooled jobs, as the second condition, one of the plurality of MFPs that has the least default setting number is selected. In the case where an MFP having the less default setting number is selected, the user of the PC and other user are unlikely to simultaneously output print jobs to the same MFP. Accordingly, it is possible to select an MFP that is expected to complete a print job the earliest.

Note that, in the second modification, when a PC selects a destination MFP, the PC does not use the number of spooled pages that is the total number of pages of print jobs being spooled in each MFP. Accordingly, each MFP does not necessarily need to notify the PC of the number of spooled pages.

<Third Modification>

In the second modification, as the first condition for the printer selection unit to select a destination MFP, the number of print jobs currently being spooled in each MFP is used.

Compared with this, in the third modification, as the first condition for the printer selection unit to select a destination MFP, the number of pages of print jobs currently being spooled in each MFP is used.

In the third modification, like the first and second modifications, the printer selection unit of each PC generates a printer selection screen including an urgent print key (see FIG. 11). However, the third modification differs from the first and second modifications in operations in the case where the user clicks the urgent print key.

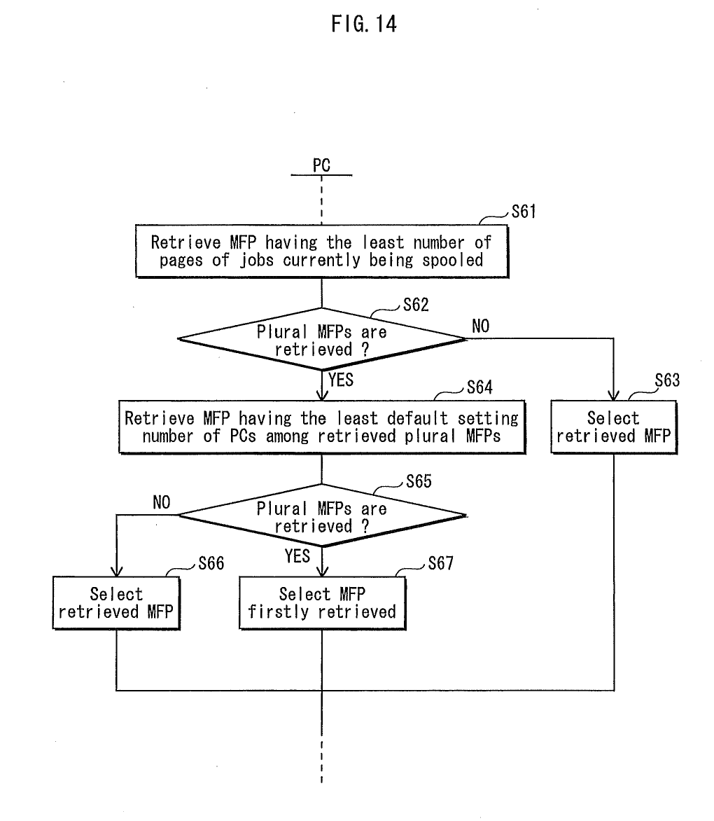

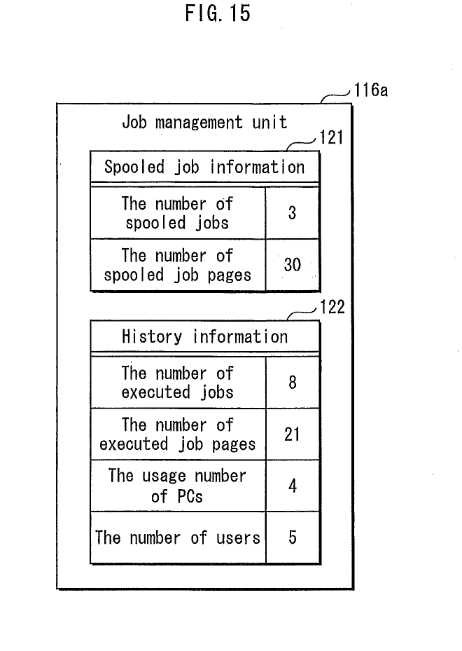

FIG. 14 is a flow chart showing the operations of printer selection processing relating to the third modification. Here, like the second modification, the operations of Step S44 shown in FIG. 12 are replaced with the flow (Steps S61 to S67) shown in FIG. 14, and only the operations different from the first embodiment and the first modification are described.

If the user clicks the urgent print key, the selection unit retrieves one of the MFPs that has the least number of pages of spool print jobs (Step S61).

If only one MFP is retrieved in Step S61 (Step S62: NO), the selection unit selects the MFP retrieved in Step S61 as a destination MFP of a print job (Step S63).

If a plurality of MFPs are retrieved in Step S61 (Step S62: YES), the selection unit retrieves one of the retrieved plurality of MFPs that has the least default setting number (Step S64).

If only one MFP is retrieved in Step S64 (Step S65: NO), the selection unit selects the MFP retrieved in Step S64 as the destination MFP of the print job (Step S66).

If a plurality of MFPs are retrieved in Step S64 (Step S65: YES), the selection unit selects one of the plurality of MFPs that has been retrieved first in Step S64 as the destination MFP (Step S67).

Note that, in the third modification, when a PC selects a destination MFP, the PC does not use the number of print jobs currently being spooled in each MFP. Accordingly, each MFP does not necessarily need to notify the PC of the number of spooled jobs.

### Second Embodiment

The following describes an image printing system relating to a second embodiment of the present invention, focusing the difference between the first embodiment and the second embodiment.

<Structure>

1. System Structure

The image printing system relating to the second embodiment has the same system structure as the image printing system 1 relating to the first embodiment. Accordingly, the system structure relating to the second embodiment is not shown in the figure. Apparatuses included in the system are described using the numerical references used in the first embodiment (see FIG. 1).

In the first embodiment and the modifications thereof, each PC selects a destination MFP of a print job based on the default setting number recorded in each MFP, the number of print jobs being spooled in the MFP, and the total number of pages of the spooled print jobs.

Compared with this, in the second embodiment, each PC selects a destination MFP of a print job based on the number of print jobs executed by each MFP in the past predetermined period and so on, in addition to the default setting number recorded in the MFP, the number of print jobs being spooled in the MFP, and the total number of pages of the spooled print jobs.

2. Structure of MFP 1(10)

The following describes the structure of the MFP 1(10) relating to the second embodiment, focusing the difference between the first embodiment and the second embodiment.

In the first embodiment, the job management unit 116 of the MFP 1(10) manages, as job information, the number of print jobs currently being spooled in the MFP 1(10) and the total number of pages of the spooled print jobs.

Compared with this, in the second embodiment, as shown in FIG. 15, a job management unit 116a of the MFP 1(10) manages spooled job information 121 and history information 122.

The spooled job information 121 is the same as job information relating to the first embodiment. That is, the spooled job information 121 indicates the number of print jobs currently being spooled in the MFP 1(10) and the number of the spooled job pages.

The history information 122 includes the number of executed jobs, the number of executed pages, the usage number of PCs, and the number of users.

The number of executed jobs indicates the number of print jobs that have been executed by the MFP 1(10) in the past predetermined period. The number of executed pages indicates the total number of pages of printed jobs that have been executed by the MFP 1(10) in the past predetermined period. The usage number of PCs indicates the number of PCs that have output print jobs to the MFP 1(10) in the past predetermined period. The number of users indicates the number of users who have output print jobs to the MFP 1(10) in the past predetermined period. Here, the predetermined period is approximately 10 to 30 minutes in length, for example. In the following description, the predetermined period is “10 minutes” in length.

When the job reception unit 115 receives a new print job, the job management unit 116a updates the number of spooled jobs and the number of spooled pages that are included in the spooled job information 121 by adding the number of the received print jobs and the number of pages of the received print jobs to the number of spooled jobs and the number of spooled pages, respectively.

Then, when the printer unit 106 completes the print job, the job management unit 116a updates the number of spooled jobs and the number of spooled pages included in the spooled job information 121 by subtracting the number of the completed print jobs and the number of pages of the completed print jobs from the number of spooled jobs and the number of spooled pages, respectively.

Furthermore, when the printer unit 106 completes the print job, the job management unit 116a updates the number of executed jobs and the number of executed pages included in the history information 122 by adding the number of the completed print jobs and the number of pages of the completed print jobs to the number of executed jobs and the number of executed pages, respectively.

Also, the job management unit 116a updates the usage number of PCs and the number of users included in the history information 122, as necessary.

Specifically, if a PC that has output a print job, which is currently completed, is a PC that has output a print job first for the last 10 minutes, the job management unit 116a increments the usage number of PCs included in the history information 122. The job management unit 116a identifies a PC that has output a print job using an ID of a printer driver received from the PC, and manages the usage number of PCs included in the history information 122.

More specifically, the job management unit 116a records therein an ID of a printer driver of each of all PCs that have output print jobs in the last 10 minutes. Then, when a print job is newly completed, the job management unit 116a compares IDs of printer drivers recorded therein with an ID of a printer driver received from a PC that has output the print job, which is newly completed, to judge whether the PC that has output the print job, which is newly completed, is a PC that has output a print job first in the last 10 minutes.

Also, if a user who has output a print job, which is currently completed, is a user who has output a print job first in the last 10 minutes, the job management unit 116a increments the number of users included in the history information 122. Here, the job management unit 116a identifies a user who has output a print job using a user ID received from a PC that has output the print job, and manages the number of users included in the history information 122.

More specifically, the job management unit 116a records therein a user ID of each of all users who have output print jobs in the last 10 minutes. Then, when a print job is newly completed, the job management unit 116a compares user IDs recorded therein with a user ID received from a PC that has output the print job, which is newly completed, to judge whether a user who has output the newly completed print job is a user who has output a print job first in the last 10 minutes.

Furthermore, the job management unit 116a updates the history information 122 by performing subtraction with respect to any relevant item among the number of executed jobs, the number of executed pages, the usage number of PCs, and the number of users for each 10 minutes. Alternatively, the following structure may be employed. For example, the job management unit 116a judges whether the history information 122 needs to be updated for each minute. If judging that the history information 122 needs to be updated, the job management unit 116a updates any of the number of executed jobs, the number of executed pages, the usage number of PCs, and the number of users.

Upon receiving a transmission request for history information from a PC, the job information notification unit 117 relating to the second embodiment transmits history information recorded in the job management unit 116a to the PC.

The MFP 1(10) relating to the second embodiment has the same structure and functions as that relating to the first embodiment, and accordingly description thereof is omitted.

Also, the MFP 2(20) and the MFP 3(30) relating to the second embodiment have the same structure and functions as the MFP 1(10), and accordingly description thereof is omitted.

3. Structure of PC 1(40)

The hardware structure of the PC 1(40) relating to the second embodiment is the same as that relating to the first embodiment shown in FIG. 4.

The functions of the printer selection unit 410 (see FIG. 5) of the PC 1(40) relating to the second embodiment partially differs from those relating to the first embodiment. Accordingly, the functions of the printer selection unit 410 relating to the second embodiment are described, focusing the difference between the first embodiment and the second embodiment.

In the second embodiment, each MFP needs to identify a PC that has output a print job to the MFP and a user who has output the print job to manage the usage number of PCs and the number of users with respect to the MFP.

Accordingly, when receiving a print job, the print job reception unit 413 requests a user to input his user ID. The print job reception unit 413 notifies the print job output unit 417 of the received user ID. Then, the print job output unit 417 attaches the user ID and an ID of a printer driver to the print job for output to an MFP.

Upon receiving an instruction from the default setting number collection unit 414, the job information collection unit 415 collects spooled job information and history information from each of the MFPs 1, 2, and 3.

The selection unit 416 of the printer selection unit 410 receives the default setting number with respect to each MFP from the default setting number collection unit 414, and receives spooled job information (the number of print jobs currently being spooled in each MFP and the total number of pages of the spooled print jobs) from the job information collection unit 415.

Furthermore, the selection unit 416 receives, from the job information collection unit 415, history information with respect to each MFP (the number of print jobs executed in the past predetermined period, the total number of pages of the executed print jobs, the number of PCs that have output the print jobs, and the number of users who have output the print jobs).

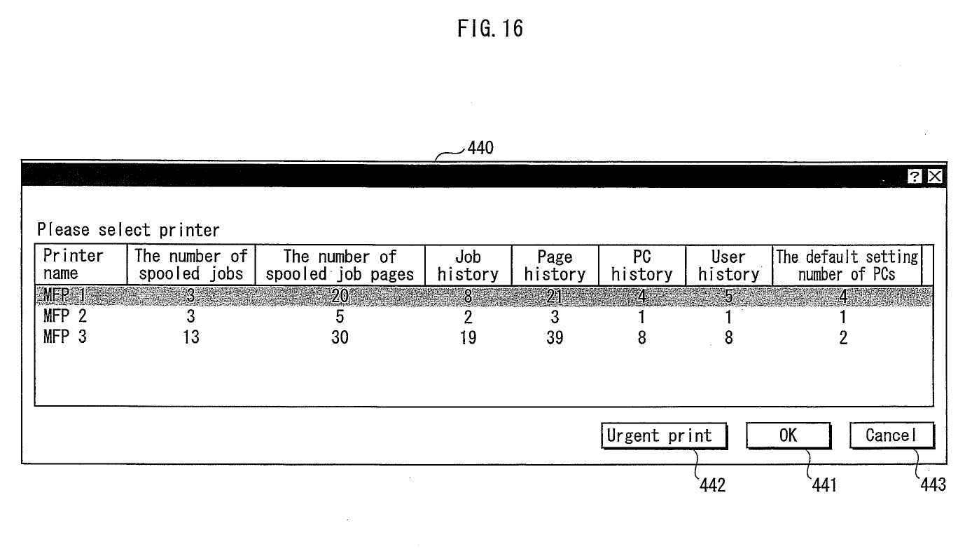

Then, the selection unit 416 generates a printer selection screen 440 shown in FIG. 16 based on the received information.

The printer selection screen 440 includes, with respect to each of the MFP 1(10), the MFP 2(20), and the MFP 3(30), a table, an OK key 441, an urgent print key 442, and a Cancel key 443. In the table, a printer name, the number of spooled jobs, the number of spooled pages, a job history, a page history, a PC history, a user history, and the default setting number are stored in correspondence with one another.

The job history indicates the number of executed jobs included in the history information acquired by the selection unit 416. Similarly, the page history indicates the number of executed pages included in the history information, the PC history indicates the usage number of PCs included in the history information, and the user history indicates the number of users included in the history information.

As shown in FIG. 16, the number of jobs being spooled in the MFP 1(10) is three, and the number of pages of the spooled jobs is 30. The number of print jobs executed by the MFP 1(10) in the past predetermined period is eight, and the number of pages of the jobs executed in the past predetermined period is 21. The number of PCs that have output print jobs to the MFP 1(10) in the past predetermined period is four, and the number of users who have output print jobs in the past predetermined period is five.

The operations performed in the case where the user selects the OK key 441, the urgent print key 442, and the Cancel key 443 are described later, respectively.

Other PCs such as the PC 2(50) and the PC 3(60) relating to the second embodiment have the same structures as the PC 1(40), and accordingly description thereof is omitted.

<Operations>

Next, the operations of the image printing system relating to the second embodiment are described.

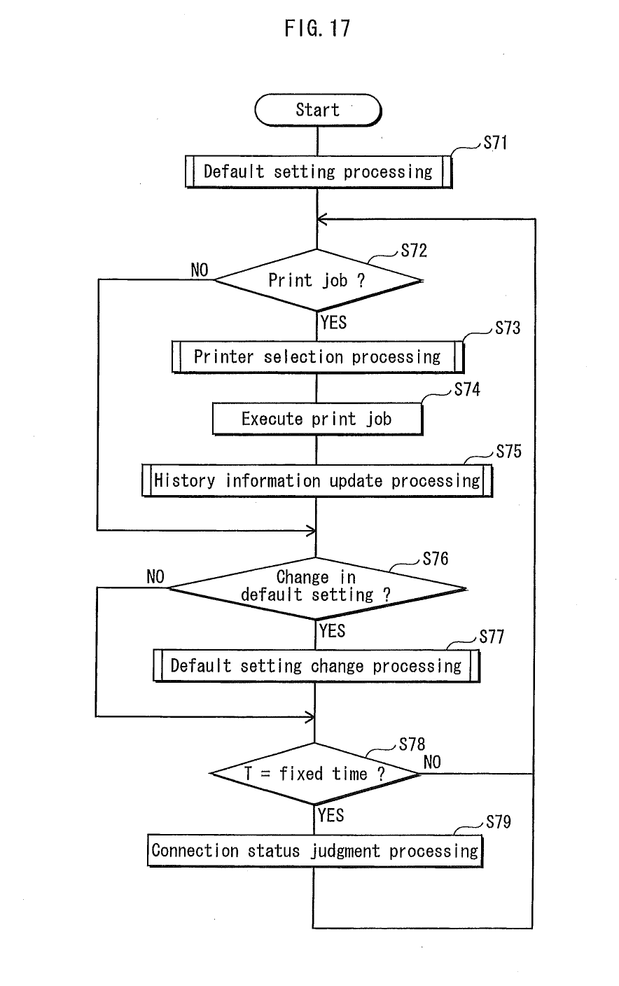

FIG. 17 is a flow chart showing the whole operations of the image printing system relating to the second embodiment. The operations relating to the second embodiment shown in FIG. 17 differ in the following two points from the operations relating to the first embodiment shown in FIG. 8.

Firstly, the second embodiment differs in operations of printer selection processing of Step S73 from the first embodiment.

Secondly, the second embodiment differs from the first embodiment in that history information update processing of Step S75 is added subsequent to print processing of Step S74. The details of the history information update processing are described later.

Other Steps in FIG. 17 are the same as those relating to the first embodiment (see FIG. 8).

1. Operations of Printer Selection Processing

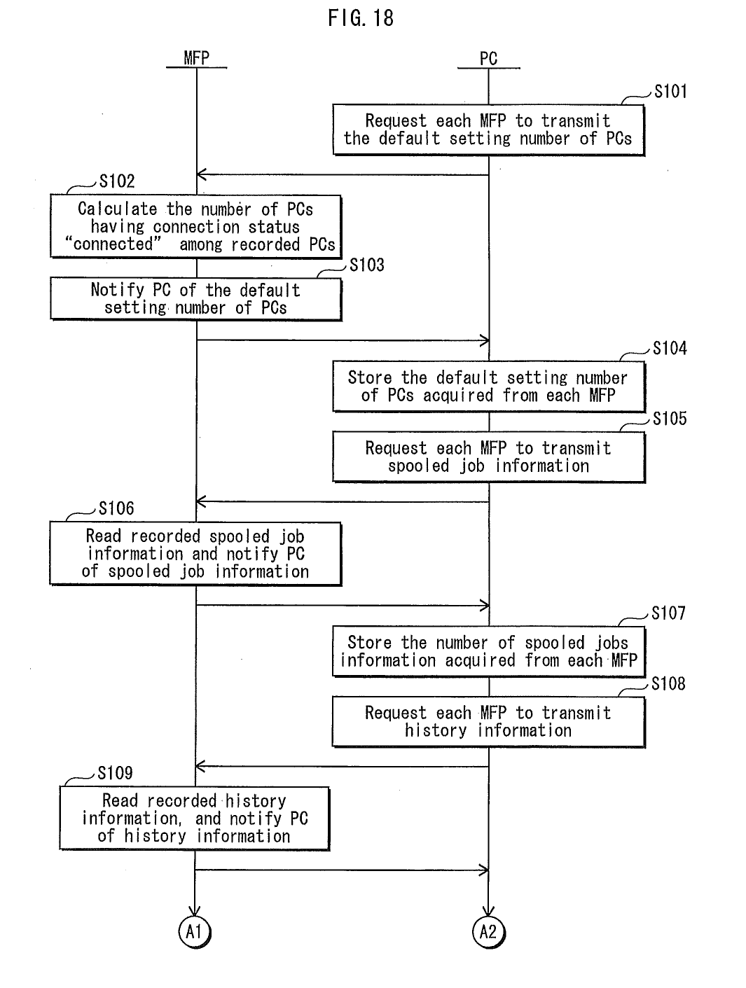

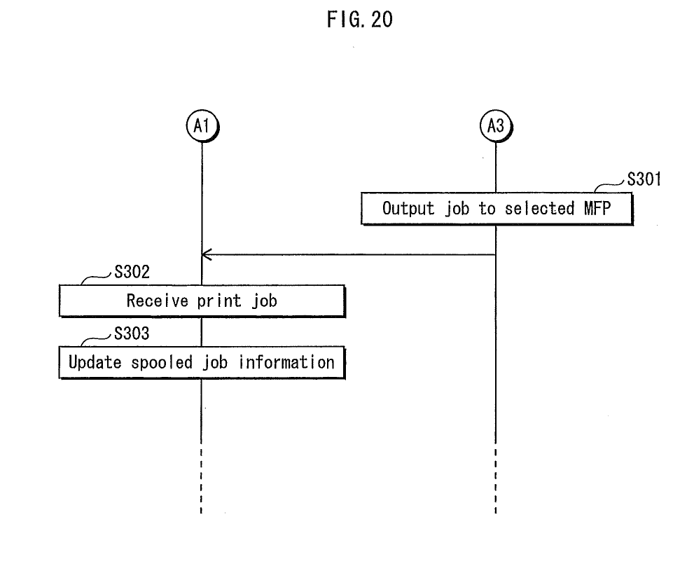

The operations of the printer selection processing are described here, with reference to flow charts shown in FIG. 18 to FIG. 20. The operations described here are the details of Step S73 shown in FIG. 17.

The default setting number collection unit of the PC that has received a print job transmits a transmission request for the default setting number to each of the MFP 1(10), the MFP 2(20), and the MFP 3(30) (Step S101).

Upon receiving the transmission request for the default setting number from the PC, the default setting number notification unit of each MFP calculates the number of PCs whose connection status is “connected” among PCs recorded in the terminal information management unit (Step S102). Then, each MFP notifies the PC of the number of PCs calculated in Step S102 as the default setting number (Step S103).

The default setting number collection unit of the PC acquires the default setting number from each MFP. The selection unit stores therein the acquired default setting numbers (Step S104).

Next, the job information collection unit of the PC transmits a transmission request for spooled job information to each of the MFP 1(10), the MFP 2(20), and the MFP 3(30) (Step S105).

Upon receiving the transmission request for job information from the PC, the job information notification unit of each MFP reads spooled job information from the job management unit. Then, the job information notification unit notifies the PC of the read spooled job information (Step S106).

The job information collection unit of the PC acquires spooled job information from each MFP, and the selection unit stores therein the acquired spooled job information pieces (Step S107).

Next, the job information collection unit of the PC transmits a transmission request for history information to each of the MFP 1(10), the MFP 2(20), and the MFP 3(30) (Step S108).

Upon receiving the transmission request for history information from the PC, the job information notification unit of each MFP reads history information from the job management unit. Then, the job information notification unit notifies the PC of the read history information (Step S109).

The job information collection unit of the PC acquires the history information from each MFP, and the selection unit stores therein the acquired history information pieces (Step S201).

Then, the selection unit generates a printer selection screen as shown in FIG. 16 based on the default setting numbers, the spooled job information pieces, and the history information pieces that are stored therein, and displays the generated printer selection screen (Step S202).

Then, the selection unit receives an input from the user (Step S203).

If the user clicks the OK key (Step S204: “OK”), the selection unit determines an MFP selected on the printer selection screen as a destination MFP of the print job (Step S205). In an example of the printer selection screen 440 shown in FIG. 16, the MFP 1 is selected.

If the user clicks the Cancel key (Step S204: “Cancel”), the selection unit selects, as the destination MFP, an MFP set as a default MFP (Step S207).

If the user clicks the urgent print key, the selection unit retrieves one of the MFPs that has the least number of spooled jobs (Step S208).

If only one MFP is retrieved in Step S208 (Step S209: NO), the selection unit selects the MFP retrieved in Step S208 as the destination MFP (Step S210).

If a plurality of MFPs are retrieved in Step S208 (Step S209: YES), the selection unit retrieves one of the retrieved plurality of MFPs that has the least page history (Step S211).

If only one MFP is retrieved in Step S211 (Step S212: NO), the selection unit selects the MFP retrieved in Step S211 as the destination MFP (Step S213).

If a plurality of MFPs is retrieved in Step S211 (Step S212: YES), the selection unit retrieves one of the retrieved plurality of MFPs that has the least default setting number (Step S214).

If only one MFP is retrieved in Step S214 (Step S215: NO), the selection unit selects the MFP retrieved in Step S214 as the destination MFP (Step S216).

If a plurality of MFPs are retrieved in Step S214 (Step S215: YES), the selection unit selects one of the plurality of MFPs that has been retrieved first in Step S214 as the destination MFP (Step S217).

The print job output unit outputs the print job to the MFP selected by the selection unit (Step S301). Here, the print job output unit outputs the print job having attached thereto an ID of a printer driver and a user ID received from the user.

Upon receiving the print job from the PC (Step S302), the job reception unit of the selected MFP updates the spooled job information (the number of spooled jobs and the number of spooled pages) recorded in the job management unit (Step S303).

2. Operations of History Information Update Processing

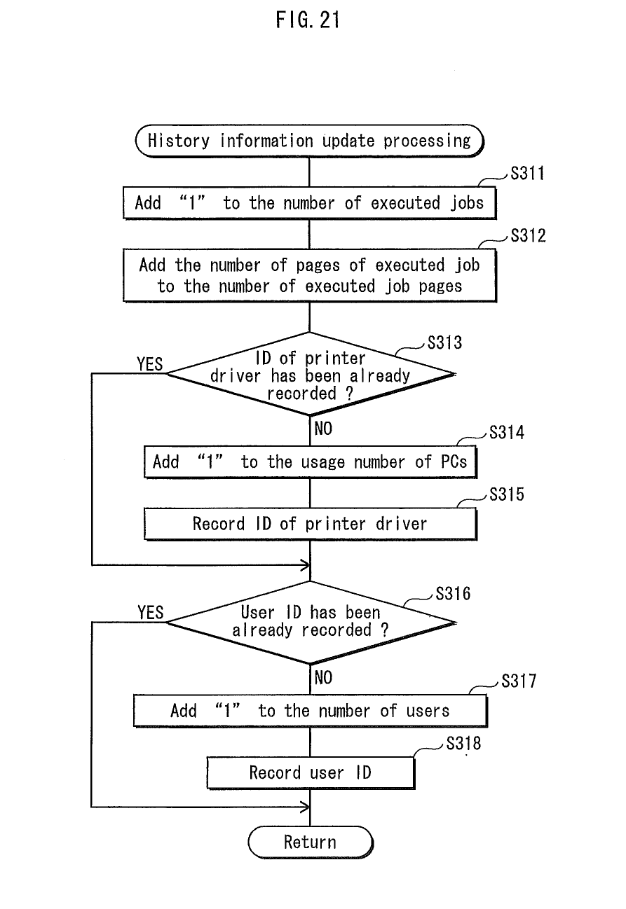

Here, the operations of history information update processing are described with reference to a flow chart shown in FIG. 21. The operations described here are the details of Step S75 shown in FIG. 17.

The job management unit of an MFP adds a value “1” to the number of executed jobs included in history information (Step S311). Next, the job management unit adds the number of pages of the print job that have been executed in Step S74 to the number of executed pages included in the history information (Step S312).

The job management unit judges whether an ID of a printer driver of the PC that has output the print job, which is currently executed in Step S74, has been already recorded therein (Step S313). If the ID has been already recorded therein (Step S313: YES), the job management unit does not need to update the usage number of PCs included in the history information, and the flow proceeds to Step S316.

If the ID has not been recorded yet (Step S313: NO), the PC that has output the print job, which is currently executed in Step S74, is a PC that has output a print job first in the last 10 minutes. Accordingly, the job management unit adds a value “1” to the usage number of PCs included in the history information (Step S314), and records therein the ID of the printer driver (Step S315).

Then, the job management unit judges whether a user ID of the user who has output the print job executed in Step S74 has been already recorded therein (Step S316). If the user ID has been already recorded therein (Step S316: YES), the job management unit does not need to update the number of users included in the history information, and then ends the processing.

If the user ID has not been recorded therein yet (Step S316: NO), the user having the user ID is a user who has output a print job first in the last 10 minutes. Accordingly, the job management unit adds a value “1” to the number of users included in the history information (Step S317), records therein the user ID (Step S318), and then ends the processing.

This completes the description of the operations of the image printing system relating to the second embodiment.

In the second embodiment, as the first condition for selection of a destination MFP, one of MFPs that has the least number of spooled jobs is selected.

Then, if a plurality of MFPs are selected, as the second condition for the selection, one of the selected plurality of MFPs that has the least number of pages printed in the past predetermined period is selected.

Then, if a plurality of MFPs is selected, as the third condition for the selection, one of the selected plurality of MFPs that has the least default setting number is selected.

In other words, in the second embodiment, it is predictable that an MFP having the less number of pages printed in the last predetermined period is currently operated by less users. Furthermore, the user of the PC and other user are unlikely to simultaneously output print jobs to an MFP having the less default setting number. Accordingly, it is possible to select an MFP that is expected to complete a print job the earliest.

### Other Modification Examples

Although the present invention has been described based on the above embodiments, the present invention is not of course limited to the above embodiments. The present invention includes, for example, the following implementation cases of the above embodiments to which modifications have been added, for example.

(1) In the first and second embodiments, when the user issues a printing instruction of a document, the PC displays a printer selection screen (see FIG. 7, FIG. 11, and FIG. 16). However, the present invention includes a case where the PC does not display the printer selection screen.

When the user issues a printing instruction of a document, the PC may automatically select, using the instruction as a trigger, a destination MFP of a print job based on job information, the default setting number, and history information.

In this case, the PC may have the mechanism for setting a print output mode to a “normal mode” or an “urgent mode”.

In the “normal mode”, when the user issues a printing instruction of a document, the PC outputs the print job to an MFP set as its default printer.

In the “urgent mode”, when the user issues a printing instruction of a document, the PC may select an MFP that is expected to complete the print job the earliest without regard to the default setting.

(2) Furthermore, the present invention includes a case where a destination MFP of a print job is selected based on only the default setting number.

For example, in the first embodiment, only the default setting number is displayed on the printer selection screen 420. The user selects a destination MFP with reference to the default setting number with respect to each MFP.

As described in the above modification example (1), in the case where the printer selection screen is not displayed, when the user issues a printing instruction of a document, a PC selects an MFP having the least default setting number using the instruction as a trigger.

(3) In the first and second embodiments, an MFP notifies a PC of the number of spooled jobs and the number of spooled pages as job information. Alternatively, the present invention may include the structure in which the MFP notifies the PC of only one of the number of spooled jobs and the number of spooled pages.

Also, in the second embodiment, the MFP notifies the PC of, as history information, the number of executed jobs, the number of executed pages, the usage number of PCs, and the number of users. Alternatively, the present invention may include the structure in which the MFP notifies the PC of at least one of the number of executed jobs, the number of executed pages, the usage number of PCs, and the number of users.

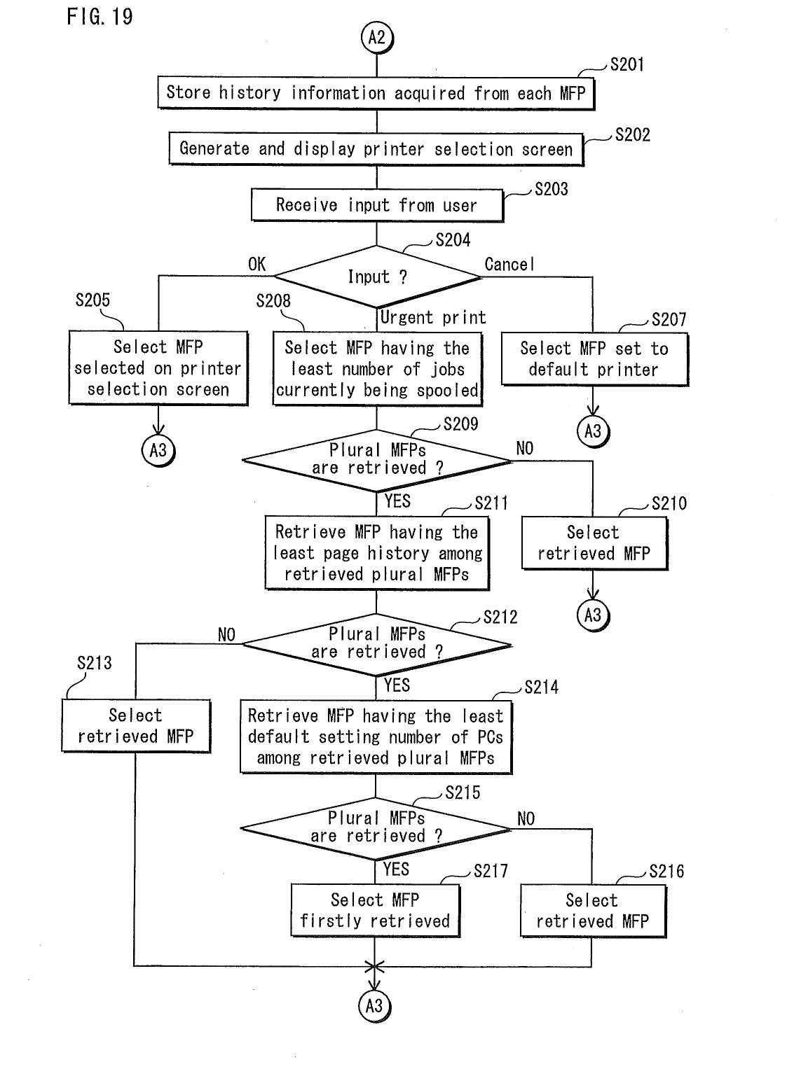

(4) In the second embodiment, a PC retrieves an MFP having the least number of spooled jobs in Step S208 of FIG. 19. Alternatively, this processing may be replaced with “processing of retrieving an MFP having the least number of spooled pages”.

Also, the PC retrieves an MFP having the least number of page histories in Step S211 of FIG. 19. Alternatively, this processing may be replaced with “processing of retrieving an MFP that has the least number of job histories”, “processing of retrieving an MFP that has the least number of PC histories”, or “processing of retrieving an MFP that has the least number of user histories”.

(5) In the second and third modifications of the first embodiment, when a PC selects a destination MFP of a print job, the number of jobs being spooled in each MFP or the total number of pages of the spooled jobs is used as the first condition for the selection. Also, the default setting number with respect to each MFP is used as the second condition for the selection.

However, the present invention is not limited to this structure. Alternatively, the default setting number may be used as the first condition for the selection, and the number of spooled jobs or the number of spooled pages may be used as the second condition for the selection.

Similarly, in the second embodiment, when a PC selects a destination MFP, spooled job information is used as the first condition for the selection, history information is used as the second condition for the selection, and the default setting number is used as the third condition for the selection.

However, the priority order of conditions for the selection is not limited to the above order. The present invention includes a case where printer selection processing is performed in other order.

(6) In the first and second embodiments, when the system is started up, and when a PC changes its default setting, the default setting reception unit of an MFP receives notification of default setting from the PC.

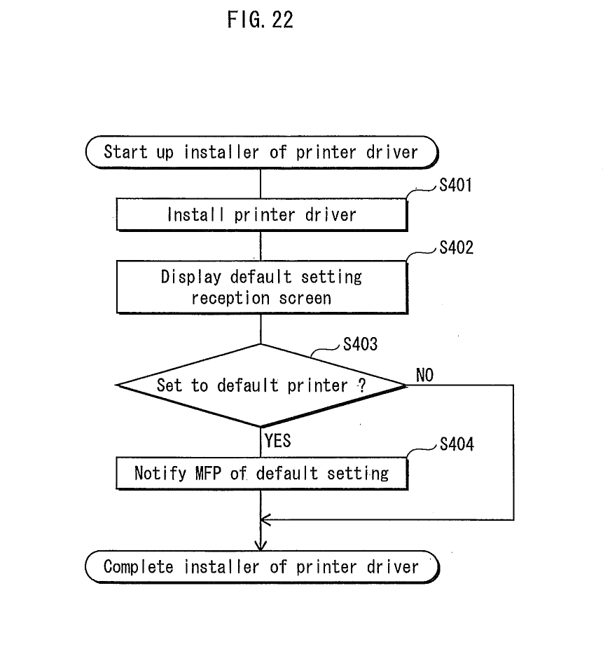

This processing may be realized by an installer of a printer driver as shown in FIG. 22, for example.

Firstly, the installer of the printer driver starts up, and the printer driver is installed in a PC (Step S401).

Then, the installer displays a default setting reception screen on the PC, and inquires the user of whether to set an MFP that is compatible with the printer driver installed in Step S401 as its default printer (Step S402).

If the compatible MFP is not set as the default printer (Step S403: NO), the installer ends the processing.

If the compatible MFP is set as the default printer (Step S403: YES), the installer notifies the MFP that is set as the default printer and other MFPs of the default setting indicating that the MFP is set as the default printer (Step S404). Then, the installer ends the processing.

(7) Also, transmission of a notification of default setting from a PC to an MFP is not limited to when the system is started up and when the PC changes its default setting. Alternatively, the PC may notify the MFP of default setting at a predetermined time.

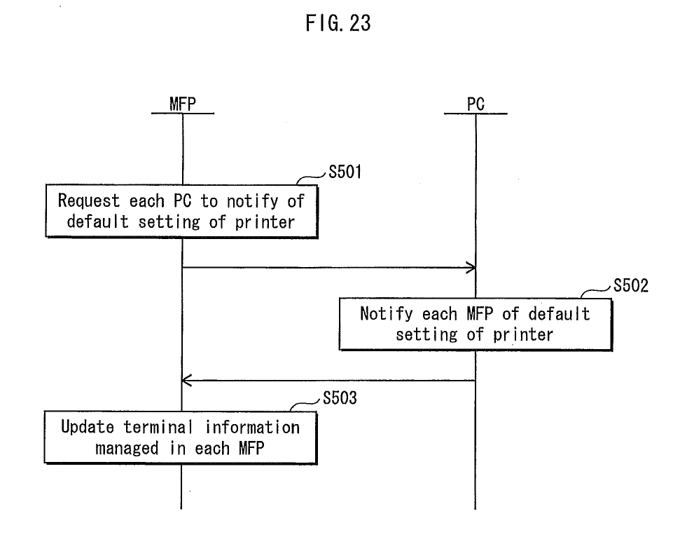

(8) Also, not only a notification of default setting is transmitted by a PC to an MFP, but also a transmission request for a notification of default setting may be issued by the MFP to the PC as shown in a flow chart of FIG. 23.

At an arbitrary time, each MFP issues a transmission request for a notification of default setting to each PC (Step S501). Upon receiving the transmission request, each PC transmits information set by the default setting unit to each MFP (Step S502).

Then, the terminal information management unit of each MFP updates information managed therein using the information received from each PC as necessary (Step S503).

(9) The present invention may be a method of selecting a destination MFP to which a PC is to output a print job. Also, the present invention may be a printer driver that realizes the method using a computer, or may be a digital signal representing the printer driver.

Also, the present invention may be the printer driver or the digital signal recorded in a computer readable recording medium such as a flexible disk, a hard disk, a CD-ROM, an MO, a DVD, a DVD-ROM, a DVD-RAM, a BD (Blu-ray Disc), and a semiconductor memory.

(10) The present invention may be any combination of the above embodiments and modifications.

### CONCLUSION

In the above embodiments and modifications, aspects for solving the problem described in the Description of the Related Art have been shown. The above embodiments and modifications are summarized as follows.

The present invention provides an image printing system that includes a plurality of image forming apparatuses and a plurality of terminal apparatuses that are connected with one another via a network, wherein each image forming apparatus manages a setting number that is a number of terminal apparatuses that each set the image forming apparatus as a default image forming apparatus for ordinary use, and each terminal apparatus selects, as a destination image forming apparatus to which a print job is to be output, one of the image forming apparatuses based on the setting number managed by each image forming apparatus, and outputs the print job to the selected destination image forming apparatus.

It is predictable that less terminal apparatuses simultaneously output print jobs to an MFP having the less setting number managed therein.

Accordingly, as shown in the above structure, one among the image forming apparatuses is selected which is expected to complete a print job the earliest based on the setting number managed by each image forming apparatuses. This can reduce the occurrence possibility of a problem that when a certain terminal apparatus outputs a print job to an image forming apparatus, other terminal apparatus also substantially simultaneously outputs a print job to the same image forming apparatus and this results in longer time to complete the print job output by the certain terminal apparatus than a user of the certain terminal apparatus thought.

Here, each terminal apparatus may comprise: a setting part operable to set one of the image forming apparatuses as the default image forming apparatus; and a first notification part operable to transmit, to the image forming apparatus set by the setting part, a notification indicating that the image forming apparatus is set as the default image forming apparatus, each image forming apparatus may comprise: a reception part operable to receive, from at least one of the terminal apparatuses, a notification indicating that the image forming apparatus is set as the default image forming apparatus; and a management part operable to manage the setting number based on the notification received by the reception part.

With this structure, each image forming apparatuses can manage the setting number that is the number of terminal apparatuses that perform “default setting” to set the image forming apparatus as a default printer for ordinary use. Note that to perform “default setting” indicates, as an example in the case of a terminal apparatus is Windows™-based, to set a printer as a “default printer”.

Here, as described in the above embodiments, the first notification part included in each terminal apparatus may notify all of the image forming apparatuses connected with the terminal apparatus via the network of its default setting. With this structure, when any of the terminal apparatuses changes its default setting, each image forming apparatus can update the setting number managed by the management part. As a result, each image forming apparatus can always correctly manage the setting number that is the number of terminal apparatuses that each set the image forming apparatus as its default image forming apparatus.

Here, each image forming apparatus may further comprise a second notification part operable to notify at least one of the terminal apparatuses of the setting number managed by the management part, each terminal apparatus may further comprise: an acquisition part operable to acquire the setting number from each image forming apparatus; and a selection part operable to select the destination image forming apparatus based on the setting numbers acquired by the acquisition part.

With this structure, each terminal apparatus acquires the setting number from all of the image forming apparatuses. Accordingly, by comparing the acquired setting numbers with one another, it is possible to select one of the image forming apparatuses that is expected to complete the print job the earliest.

Here, the selection part may select, as the destination image forming apparatus, one of the image forming apparatuses that has a least setting number.

It is the least likely that a certain terminal apparatus and other terminal apparatus simultaneously output print jobs to one of the image forming apparatuses that has the least default setting number. Accordingly, this structure can reduce the occurrence possibility of a problem that when a certain terminal apparatus outputs a print job to an image forming apparatus, other terminal apparatus also substantially simultaneously outputs a print job to the same image forming apparatus and as a result it takes longer time to complete the print job output by the certain terminal apparatus than a user of the certain terminal apparatus thought.

Here, the management part may further manage a job information piece relating to an unexecuted print job stored by the image forming apparatus, the second notification part may notify the at least one terminal apparatus of the job information piece, the acquisition part further acquires the job information piece from each image forming apparatus, and the selection part may select the destination image forming apparatus based on the setting numbers and the job information pieces acquired by the acquisition part.

In the case where a terminal apparatus requests an image forming apparatus that stores therein more unexecuted jobs to execute a new print job, it naturally takes longer time to complete the new print job.

In view of this, the structure is employed in which an image forming apparatus that is expected to complete a print job is selected based on job information and the setting number, as described above. This structure enables a terminal apparatus to more accurately select a destination image forming apparatus that is expected to complete a print job compared with case where a destination image forming apparatus is selected based only the setting number.

Here, the job information piece may be a number of print jobs spooled in the image forming apparatus, the acquisition part may acquire the number of spooled print jobs as the job information piece, and the selection part may select, as the destination image forming apparatus, one of the image forming apparatuses that has a least number of spooled print jobs or has the least number of spooled print jobs and a least setting number.

With this structure, the terminal apparatus can select, as the destination image forming apparatus, one of the image forming apparatuses that has the least number of unexecuted print jobs. Or in the case where a plurality of the image forming apparatuses each have the least number of unexecuted print jobs, the terminal apparatus can select, as the destination image forming apparatus, one of the plurality of the image forming apparatuses that has the least setting number.

Accordingly, the terminal apparatus can more accurately select an image forming apparatus that is expected to complete a print job the earliest.

Also, the job information piece may be a number of spooled pages that is a total number of pages of print jobs spooled in the image forming apparatus, the acquisition part may acquire the number of spooled pages as the job information piece, and the selection part may select, as the destination image forming apparatus, one of the image forming apparatuses that has a least number of spooled pages or has the least number of spooled pages and a least setting number.

With this structure, the terminal apparatus can select, as the destination image forming apparatus, one of the image forming apparatuses that has the least total number of pages of unexecuted print jobs. Or in the case where a plurality of the image forming apparatuses each have the least total number of pages of unexecuted print jobs, the terminal apparatus can select, as the destination image forming apparatus, one of the plurality of the image forming apparatuses that has the least setting number.

Accordingly, the terminal apparatus can further appropriately select an image forming apparatus that is expected to complete a print job the earliest.

Here, the management part may further manage a history information piece relating to a print job executed by the image forming apparatus, the second notification part may further notify the at least one terminal apparatus of the history information piece, the acquisition part may further acquire the history information piece from each image forming apparatus, and the selection part may select the destination image forming apparatus based on the setting numbers and the history information pieces acquired by the acquisition part.

For example, the more an image forming apparatus has recently executed print jobs, the more a terminal apparatus that sets the image forming apparatus as its default image forming apparatus is likely to be currently still in operation and immediately request to the image forming apparatus to execute a new print job.

In view of this, the structure is employed in which an image forming apparatus is selected based on history information that is information relating to a print job executed by each image forming apparatus in the past. This structure enables the terminal apparatus to more accurately select an image forming apparatus that is expected to complete a print job compared with a case where an image forming apparatus is selected based on only the setting number.

Here, the history information piece may be a number of print jobs executed by the image forming apparatus in a certain period, the acquisition part may acquire the number of executed print jobs as the history information piece, and the selection part may select, as the destination image forming apparatus, one of the image forming apparatuses that has a least number of executed print jobs or has the least number of executed print jobs and a least setting number.

Also, the history information piece may be a number of executed pages that is a total number of pages of print jobs executed by the image forming apparatus in a certain period, the acquisition part may acquire the number of executed pages as the history information piece, and the selection part may select, as the destination image forming apparatus, one of the image forming apparatuses that has a least number of executed pages or has the least number of executed pages and a least setting number.

Also, the history information piece may be a usage number that is a number of terminal apparatuses that have used the image forming apparatus in a certain period, the acquisition part may acquire the usage number as the history information piece, and the selection part may select, as the destination image forming apparatus, one of the image forming apparatuses that has a least usage number or has the least usage number and a least setting number.

Also, the history information piece may be the number of users that have used the image forming apparatus in a certain period, the acquisition part acquires the number of users as the history information piece, and the selection part selects, as the destination image forming apparatus, one of the image forming apparatuses that has a least number of users or has the least number of users and a least setting number.

As described above, the more an image forming apparatus has recently executed print jobs and pages, the more a terminal apparatus that sets the image forming apparatus as its default image forming apparatus is likely to be currently still in operation and immediately request the image forming apparatus to execute a new print job.

Similarly, the more an image forming apparatus has the number of terminal apparatuses and users that have recently requested the image forming apparatus to execute print jobs, the more the same terminal apparatuses and users are likely to immediately request the image forming apparatus to execute a new print job.

In view of this, the above structure is employed in which the terminal apparatus selects an image forming apparatus based on these history information pieces in addition. This structure enables the terminal apparatus to more accurately select an image forming apparatus that is expected to complete a print job the earliest compared with a case where an image forming apparatus is selected based on only the setting number.

Also, the management part may further manage, with respect to each terminal apparatus, a connection status showing whether the terminal apparatus is connected to the network, and the second notification part may notify the at least one terminal apparatus of, as the setting number, a number of terminal apparatuses that each set the image forming apparatus as the ordinary use apparatus and are connected to the network.

In other words, even in the case where a terminal apparatus that is not currently connected to the network sets an image forming apparatus as its default image forming apparatus, the terminal apparatus does not output a print job to the image forming apparatus.

Accordingly, as described above, since the terminal apparatus that is not currently connected to the network is excluded from the setting number of terminal apparatuses, each terminal apparatus can more accurately select an image forming apparatus that is expected to complete a print job the earliest.

Here, the first notification part may transmit the notification at a predetermined time.

With this structure, each terminal apparatus notifies each image forming apparatus of default setting at a predetermined time. Accordingly, the image forming apparatus can certainly collect information on default setting from the terminal apparatuses.

Here, at the predetermined time when a new printer driver is installed in the terminal apparatus, the first notification part may transmit, to one of the image forming apparatuses that is compatible with the printer driver, the notification indicating that the terminal apparatus sets the compatible image forming apparatus as the default image forming apparatus.

With this structure, when a new terminal apparatus is set up, if a printer driver is installed for example, the terminal apparatus can automatically notify each image forming apparatuses of its default setting.

Here, at the predetermined time when the setting part changes the default image forming apparatus from one of the image forming apparatuses to another one of the image forming apparatuses, the first notification part may transmit, to the another one image forming apparatus, the notification indicating that the terminal apparatus sets the another one image forming apparatus as the default image forming apparatus.

With this structure, when each terminal apparatuses changes its default image forming apparatus from a certain image forming apparatus to another image forming apparatus, the terminal apparatus notifies the another image forming apparatus of that the another image forming apparatus is newly set as the default image forming apparatus. This enables the image forming apparatus to manage the precise setting number.

Also, as described in the above embodiments, the terminal apparatus notifies the certain image forming apparatus that has been previously set as the default image forming apparatus in addition to the another image forming apparatus of that the another image forming apparatus is newly set as the default image forming apparatus. This enables all of the image forming apparatuses to manage the precise setting number.

Here, the selection part may include: a presentation subpart operable to present the acquired setting numbers to a user; a user input subpart operable to receive a selection of one of the image forming apparatuses from the user based on the setting numbers presented by the presentation subpart; and a selection subpart operable to determine, as the destination image forming apparatus, the image forming apparatus selected by the user input subpart.

In other words, each of the terminal apparatuses only presents information that is helpful for the user to make a selection. An image forming apparatus to which a print job is to be output is arbitrarily selected by the user.

Accordingly, with this structure, it is possible to keep high the degree of selection freedom of the user while presenting the helpful information to the user.

Here, the selection part may include: a user input subpart operable to receive an input from a user; and a selection subpart operable to, when an input of an urgent print job is received by the user input subpart, select the destination image forming apparatus based on the setting numbers acquired by the acquisition part.

In other words, the user does not need to select an image forming apparatus on my own. With just the user's input that indicates an urgent print job, the terminal apparatus automatically selects an image forming apparatus. In the case where many image forming apparatuses are connected with a terminal apparatus for example, the user has difficulty referring to a plurality of information pieces respectively relating to the image forming apparatuses to select one of the image forming apparatuses on his own. In the case where the user hopes to output an urgent print job in this case, the user has difficulty doing such. Accordingly, the above structure is useful in the case where the user outputs an urgent print job.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An image printing system that includes a plurality of image forming apparatuses and a plurality of terminal apparatuses that are connected with one another via a network, wherein
each image forming apparatus manages a setting number that is a number of terminal apparatuses that each set the image forming apparatus as a default image forming apparatus for ordinary use, and
each terminal apparatus selects, as a destination image forming apparatus to which a print job is to be output, one of the image forming apparatuses based on the setting number managed by each image forming apparatus, and outputs the print job to the selected destination image forming apparatus.

2. The image printing system of claim 1, wherein
each terminal apparatus comprises:
a setting part operable to set one of the image forming apparatuses as the default image forming apparatus; and
a first notification part operable to transmit, to the image forming apparatus set by the setting part, a notification indicating that the image forming apparatus is set as the default image forming apparatus,
each image forming apparatus comprises:
a reception part operable to receive, from at least one of the terminal apparatuses, a notification indicating that the image forming apparatus is set as the default image forming apparatus; and
a management part operable to manage the setting number based on the notification received by the reception part.

3. The image printing system of claim 2, wherein
each image forming apparatus further comprises
a second notification part operable to notify at least one of the terminal apparatuses of the setting number managed by the management part,
each terminal apparatus further comprises:
an acquisition part operable to acquire the setting number from each image forming apparatus; and
a selection part operable to select the destination image forming apparatus based on the setting numbers acquired by the acquisition part.

4. The image printing system of claim 3, wherein
the selection part selects, as the destination image forming apparatus, one of the image forming apparatuses that has a least setting number.

5. The image printing system of claim 3, wherein
the management part further manages a job information piece relating to an unexecuted print job stored by the image forming apparatus,
the second notification part notifies the at least one terminal apparatus of the job information piece,
the acquisition part further acquires the job information piece from each image forming apparatus, and
the selection part selects the destination image forming apparatus based on the setting numbers and the job information pieces acquired by the acquisition part.

6. The image printing system of claim 5, wherein
the job information piece is a number of print jobs spooled in the image forming apparatus,
the acquisition part acquires the number of spooled print jobs as the job information piece, and
the selection part selects, as the destination image forming apparatus, one of the image forming apparatuses that has a least number of spooled print jobs or has the least number of spooled print jobs and a least setting number.

7. The image printing system of claim 5, wherein
the job information piece is a number of spooled pages that is a total number of pages of print jobs spooled in the image forming apparatus,
the acquisition part acquires the number of spooled pages as the job information piece, and
the selection part selects, as the destination image forming apparatus, one of the image forming apparatuses that has a least number of spooled pages or has the least number of spooled pages and a least setting number.

8. The image printing system of claim 3, wherein
the management part further manages a history information piece relating to a print job executed by the image forming apparatus,
the second notification part further notifies the at least one terminal apparatus of the history information piece,
the acquisition part further acquires the history information piece from each image forming apparatus, and
the selection part selects the destination image forming apparatus based on the setting numbers and the history information pieces acquired by the acquisition part.

9. The image printing system of claim 8, wherein
the history information piece is a number of print jobs executed by the image forming apparatus in a certain period,
the acquisition part acquires the number of executed print jobs as the history information piece, and
the selection part selects, as the destination image forming apparatus, one of the image forming apparatuses that has a least number of executed print jobs or has the least number of executed print jobs and a least setting number.

10. The image printing system of claim 8, wherein
the history information piece is a number of executed pages that is a total number of pages of print jobs executed by the image forming apparatus in a certain period,
the acquisition part acquires the number of executed pages as the history information piece, and
the selection part selects, as the destination image forming apparatus, one of the image forming apparatuses that has a least number of executed pages or has the least number of executed pages and a least setting number.

11. The image printing system of claim 8, wherein
the history information piece is a usage number that is a number of terminal apparatuses that have used the image forming apparatus in a certain period,
the acquisition part acquires the usage number as the history information piece, and
the selection part selects, as the destination image forming apparatus, one of the image forming apparatuses that has a least usage number or has the least usage number and a least setting number.

12. The image printing system of claim 8, wherein
the history information piece is the number of users that have used the image forming apparatus in a certain period,
the acquisition part acquires the number of users as the history information piece, and
the selection part selects, as the destination image forming apparatus, one of the image forming apparatuses that has a least number of users or has the least number of users and a least setting number.

13. The image printing system of claim 3, wherein
the management part further manages, with respect to each terminal apparatus, a connection status showing whether the terminal apparatus is connected to the network, and
the second notification part notifies the at least one terminal apparatus of, as the setting number, a number of terminal apparatuses that each set the image forming apparatus as the ordinary use apparatus and are connected to the network.

14. The image printing system of claim 3, wherein
the selection part includes:
a presentation subpart operable to present the acquired setting numbers to a user;
a user input subpart operable to receive a selection of one of the image forming apparatuses from the user based on the setting numbers presented by the presentation subpart; and
a selection subpart operable to determine, as the destination image forming apparatus, the image forming apparatus selected by the user input subpart.

15. The image printing system of claim 3, wherein
the selection part includes:
a user input subpart operable to receive an input from a user; and
a selection subpart operable to, when an input of an urgent print job is received by the user input subpart, select the destination image forming apparatus based on the setting numbers acquired by the acquisition part.

16. The image printing system of claim 2, wherein
the first notification part transmits the notification at a predetermined time.

17. The image printing system of claim 16, wherein
at the predetermined time when a new printer driver is installed in the terminal apparatus, the first notification part transmits, to one of the image forming apparatuses that is compatible with the printer driver, the notification indicating that the terminal apparatus sets the compatible image forming apparatus as the default image forming apparatus.

18. The image printing system of claim 16, wherein
at the predetermined time when the setting part changes the default image forming apparatus from one of the image forming apparatuses to another one of the image forming apparatuses, the first notification part transmits, to the another one image forming apparatus, the notification indicating that the terminal apparatus sets the another one image forming apparatus as the default image forming apparatus.

19. An image forming apparatus connected with a plurality of terminal apparatuses via a network, the image forming apparatus comprising:
a reception part operable to receive, from at least one of the terminal apparatuses, a notification indicating that the at least one terminal apparatus sets the image forming apparatus as a default image forming apparatus for ordinary use; and
a management part operable to manage a setting number based on the notification received by the reception part, the setting number being a number of terminal apparatuses that each set the image forming apparatus as the default image forming apparatus.

20. The image forming apparatus of claim 19, further comprising
a notification part operable to, upon receiving a transmission request for the setting number from at least one of the terminal apparatuses, notify the at least one terminal apparatus of the setting number managed by the management part.

21. The image forming apparatus of claim 20, wherein
the management part further manages a job information piece relating to an unexecuted print job stored by the image forming apparatus, and
the notification part notifies the at least one terminal apparatus of the job information piece.

22. The image forming apparatus of claim 20, wherein
the management part further manages a history information piece relating to a print job executed by the image forming apparatus, and
the notification part further notifies the at least one terminal apparatus of the history information piece.

23. The image forming apparatus of claim 20, wherein
the management part further manages, with respect to each terminal apparatus, a connection status showing whether the terminal apparatus is connected to the network, and
the notification part notifies the at least one terminal apparatus of, as the setting number, a number of terminal apparatuses that each set the image forming apparatus as the ordinary use apparatus and are connected to the network.

24. A printer selection apparatus connected with a plurality of image forming apparatuses via a network, the printer selection apparatus comprising:
a selection part operable to select, based on a setting number with respect to each image forming apparatus, one of the image forming apparatuses as a destination image forming apparatus to which a print job is to be output, the setting number being a number of terminal apparatuses that each set the image forming apparatus as a default image forming apparatus for ordinary use.

25. The printer selection apparatus of claim 24, further comprising
a setting part operable to set one of the image forming apparatuses as the default image forming apparatus; and
a notification part operable to transmit, to the image forming apparatus set by the setting part, a notification indicating that the image forming apparatus is set as the default image forming apparatus.

26. The printer selection apparatus of claim 25, further comprising
an acquisition part operable to acquire, from each image forming apparatus, the setting number managed by the image forming apparatus, wherein
the selection part selects the destination image forming apparatus based on the setting numbers acquired by the acquisition part.

27. The printer selection apparatus of claim 26, wherein
the acquisition part further acquires, from each image forming apparatus, a job information piece relating to an unexecuted print job stored in the image forming apparatus, and
the selection part selects the destination image forming apparatus based on the setting numbers and the job information pieces acquired by the acquisition part.

28. The printer selection apparatus of claim 26, wherein
the acquisition part further acquires, from each image forming apparatus, a history information piece relating to a print job executed by the image forming apparatus, and
the selection part selects the destination image forming apparatus based on the setting numbers and the history information pieces acquired by the acquisition part.

29. The printer selection apparatus of claim 26, wherein
the selection part includes:
a presentation subpart operable to present the acquired setting numbers to a user;
a user input subpart operable to receive a selection of one of the image forming apparatuses from the user based on the setting numbers presented by the presentation subpart; and
a selection subpart operable to determine, as the destination image forming apparatus, the image forming apparatus selected by the user input subpart.

30. The printer selection apparatus of claim 26, wherein
the selection part includes:
a user input subpart operable to receive an input from a user; and
a selection subpart operable to, when an input of an urgent print job is received by the user input subpart, select the destination image forming apparatus based on the setting numbers acquired by the acquisition part.

31. A terminal apparatus that outputs a print job to the image forming apparatus selected by the printer selection apparatus of claim 24.

32. A computer readable recording medium having recorded therein a printer driver for use in a terminal apparatus connected with a plurality of image forming apparatuses via a network, wherein
when an urgent print job is to be output, the printer driver selects, based on a setting number with respect to each image forming apparatus, one of the image forming apparatuses as a destination image forming apparatus to which the urgent print job is to be output, the setting number being a number of terminal apparatuses that each set the image forming apparatus as a default image forming apparatuses for ordinary use.

33. The recording medium of claim 32, wherein
the printer driver comprises:
a setting step of setting one of the image forming apparatuses as the default image forming apparatus; and
a notification step of transmitting, to the image forming apparatus set by the setting part, a notification indicating that the image forming apparatus is set as the default image forming apparatus.

34. The recording medium of claim 33, wherein
the printer driver further comprises:
an acquisition step of acquiring, from each image forming apparatus, the setting number managed by the image forming apparatus; and
a selection step of selecting the destination image forming apparatus based on the setting numbers acquired by the acquisition step.

35. The recording medium of claim 34, wherein
the acquisition step further acquires, from each image forming apparatus, a job information piece relating to an unexecuted print job stored in the image forming apparatus, and
the selection step selects the destination image forming apparatus based on the setting numbers and the job information pieces acquired by the acquisition part.

36. The recording medium of claim 34, wherein
the acquisition step further acquires, from each image forming apparatus, a history information piece relating to a print job executed by the image forming apparatus, and
the selection step selects the destination image forming apparatus based on the setting numbers and the history information pieces acquired by the acquisition part.

37. The recording medium of claim 34, wherein
the selection step includes:
a presentation substep of presenting the acquired setting numbers to a user;
a reception substep of receiving a selection of one of the image forming apparatuses from the user based on the setting numbers presented by the presentation substep; and
a selection substep of determining, as the destination image forming apparatus, the image forming apparatus selected by the user.

38. The recording medium of claim 34, wherein
the selection step includes:
a reception substep of receiving an input of an urgent print job from a user; and
a selection subpart of selecting the destination image forming apparatus based on the setting numbers acquired by the acquisition step.
